(19) United States
(12) Patent Application Publication
(10) Pub. No.: US 2026/0213634 A1
(43) Pub. Date: Jul. 23, 2026

(54) METHOD AND APPARATUS FOR REVERSING INDUCTION OF DISADVANTAGEOUS EMF FROM ELECTRICAL CONNECTION MOVING IN RETURN FLUX

(71) Applicant: NextPower360 Co., Leicester, NC (US)

(72) Inventors: Benedetto Anthony IACOVELLI, Leicester, NC (US); Norm SHILLING, Leicester, NC (US)

(21) Appl. No.: 19/455,177

(22) Filed: Jan. 21, 2026

Related U.S. Application Data
(60) Provisional application No. 63/747,953, filed on Jan. 22, 2025.

(51) Int. Cl. H02K 31/02

(52) U.S. Cl. CPC H02K 31/02

(57) ABSTRACT

A homopolar dynamoelectric machine includes stator layers spaced radially apart from one another, rotor layers each respectively provided between a pair of the stator layers and rotatable through a stationary magnetic field generated by the stator layers, electrical windings which electrically connect axial ends of the rotor layers in series, parallel, or a combination of series and parallel, and at least one flux return mitigation assembly to interact with flux of the magnetic field generated by the stator layers. The at least one flux return mitigation assembly includes a switchback structure which is contoured to direct the flux of the magnetic field generated by the stator layers through a portion of the electrical windings.

### CROSS-REFERENCE TO RELATED APPLICATIONS

The present application claims priority to U.S. Patent Application No. 63/747,953, filed on Jan. 22, 2025, the entire contents of which are hereby incorporated herein by reference.

### BACKGROUND OF THE INVENTION

### 1. Field of the Invention

The present invention relates to novel methods, structures, and systems for improving generators and motors. More specifically, the present invention relates to electrically connecting two or more homopolar rotors in series in a manner that does not require the use of sliding contacts.

### 2. Description of the Related Art

Homopolar generators can approach the theoretical highest possible specific energy density, reliability, cost effectiveness, and longevity, but the power they make, while being very impressive in quantity, is of the wrong profile. There are two problems that have kept homopolar machines, despite their overwhelmingly ideal physics, from being practical.
Problem 1: homopolar generators make a tremendous amperage paired with a tiny voltage. The voltage is so low that internal and sliding contact resistance keeps the majority of the power from being expressed in a usable manner.
Problem 2: the flux return can create a reverse voltage in the electrical connections that interferes with connecting rotors in series to add their voltages.

### SUMMARY OF THE INVENTION

To overcome the problems described above, example embodiments of the present invention provide alternative and new ways of electrically connecting rotors of a homopolar motor/generator assembly.

According to an example embodiment of the present invention, a homopolar dynamoelectric machine includes stator layers spaced radially apart from one another, rotor layers each respectively provided between a pair of the stator layers and rotatable through a stationary magnetic field generated by the stator layers, electrical windings which electrically connect axial ends of the rotor layers in series, parallel, or a combination of series and parallel, and at least one flux return mitigation assembly to interact with flux of the magnetic field generated by the stator layers. The at least one flux return mitigation assembly includes a switchback structure which is contoured to direct the flux of the magnetic field generated by the stator layers through a portion of the electrical windings.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

FIG. 1 shows a perspective view of an axial end of a Faraday drum homopolar machine according to an example embodiment of the present invention.

FIG. 2A shows a radial direction cross section of a cylindrical machine according to an example embodiment of the present invention.

FIG. 2B shows flux returns and flux density of one lateral side portion of the radial cross section of the cylindrical machine of FIG. 2A.

FIG. 3 shows flux returns with blocking magnets of dynamoelectric machine according to an example embodiment of the present invention and a flux density thereof.

FIG. 4 shows flux returns of a dynamoelectric machine with blocking magnets according to an example embodiment of the present invention and a flux density thereof.

FIG. 5 shows an unshielded wire extending upward in a stator according to an example embodiment of the present invention and a flux density thereof.

FIG. 6 shows flux returns with blocking magnets according to an example embodiment of the present invention and a flux density thereof.

FIG. 7 shows flux returns with blocking magnets of according to an example embodiment of the present invention in which intake and output sides have been translated laterally and a flux density thereof.

FIG. 8 shows flux returns with blocking magnets of an example embodiment of the present invention which have been skewed and a flux density thereof.

FIG. 9 shows flux returns with an additional magnet according to an example embodiment of the present invention and a flux density thereof.

FIG. 10A shows flux returns with a skewed gap and FIG. 10B shows flux returns with a skewed gap and an additional magnet according to an example embodiment of the present invention and a flux density thereof.

FIG. 11 shows flux returns with blocking magnets according to an example embodiment of the present invention which have been skewed and a flux density thereof.

FIG. 12 shows flux returns with blocking magnets according to an example embodiment of the present invention and a flux density thereof.

FIG. 13 shows flux returns with blocking magnets which are skewed according to an example embodiment of the present invention and a flux density thereof.

FIGS. 14A and 14B show flux returns with blocking magnets which are respectively aligned and skewed according to an example embodiment of the present invention and a flux density thereof.

FIGS. 15A and 15B show flux returns with blocking magnets in which changes to the flux density thereof caused by an additional iron portion added to a tail can be seen.

FIG. 16 shows flux returns with blocking magnets which according to an example embodiment of the present invention and a flux density thereof.

FIG. 17 shows flux returns with blocking magnets which are skewed according to an example embodiment of the present invention and a flux density thereof.

FIG. 18 shows flux returns with blocking magnets which are skewed according to an example embodiment of the present invention and a flux density thereof.

FIG. 19 shows flux returns with blocking magnets according to an example embodiment of the present invention and a flux density thereof.

FIG. 20 shows flux returns with blocking magnets according to an example embodiment of the present invention and a flux density thereof.

FIG. 21 shows flux returns with blocking magnets according to an example embodiment of the present invention and a flux density thereof.

FIG. 22 shows flux returns with blocking magnets according to an example embodiment of the present invention and a flux density thereof.

FIG. 23 shows flux returns with blocking magnets according to an example embodiment of the present invention and a flux density thereof.

FIG. 24 shows flux returns with blocking magnets according to an example embodiment of the present invention and a flux density thereof.

FIG. 25 shows flux returns with blocking magnets which are skewed according to an example embodiment of the present invention and a flux density thereof.

FIGS. 26A and 26B show flux returns with blocking magnets in which changes to the flux density thereof caused by an additional thinner blocking magnet can be seen.

FIG. 27 shows flux returns with blocking magnets which are skewed according to an example embodiment of the present invention and a flux density thereof.

FIG. 28 shows flux returns with blocking magnets which are skewed according to an example embodiment of the present invention and a flux density thereof.

FIG. 29 shows flux returns with blocking magnets which are skewed according to an example embodiment of the present invention and a flux density thereof.

FIG. 30 shows flux returns with blocking magnets which are skewed according to an example embodiment of the present invention and a flux density thereof.

FIG. 31 shows flux returns with blocking magnets which are skewed according to an example embodiment of the present invention and a flux density thereof.

FIG. 32 shows flux returns with blocking magnets which are skewed according to an example embodiment of the present invention and a flux density thereof.

FIG. 33 shows flux returns with blocking magnets according to an example embodiment of the present invention and a flux density thereof.

FIG. 34 shows flux returns with blocking magnets which are skewed according to an example embodiment of the present invention and a flux density thereof.

FIG. 35 shows flux returns with blocking magnets according to an example embodiment of the present invention and a flux density thereof.

FIG. 36 shows flux returns with blocking magnets according to an example embodiment of the present invention and a flux density thereof.

FIG. 37 shows flux returns with blocking magnets according to an example embodiment of the present invention and a flux density thereof.

FIG. 38 shows flux returns with blocking magnets according to an example embodiment of the present invention and a flux density thereof.

FIG. 39 shows flux returns with blocking magnets according to an example embodiment of the present invention and a flux density thereof.

FIG. 40 shows flux returns with blocking magnets according to an example embodiment of the present invention and a flux density thereof.

FIG. 41 shows flux returns with blocking magnets according to an example embodiment of the present invention and a flux density thereof.

FIG. 42 shows flux returns with blocking magnets according to an example embodiment of the present invention and a flux density thereof.

FIG. 43 shows flux returns with blocking magnets according to an example embodiment of the present invention and a flux density thereof.

FIG. 44 shows flux returns with blocking magnets according to an example embodiment of the present invention and a flux density thereof.

FIG. 45 shows flux returns with blocking magnets according to an example embodiment of the present invention and a flux density thereof.

FIG. 46 shows flux returns with blocking magnets according to an example embodiment of the present invention and a flux density thereof.

FIG. 47 shows flux returns with blocking magnets according to an example embodiment of the present invention and a flux density thereof.

FIG. 48 shows flux returns with blocking magnets according to an example embodiment of the present invention and a flux density thereof.

FIG. 49 shows flux returns with blocking magnets according to an example embodiment of the present invention and a flux density thereof.

FIG. 50 shows flux returns with blocking magnets according to an example embodiment of the present invention and a flux density thereof.

FIG. 51 shows flux returns with blocking magnets according to an example embodiment of the present invention and a flux density thereof.

FIG. 52 shows flux returns with blocking magnets according to an example embodiment of the present invention and a flux density thereof.

FIG. 53 shows a location of flux returns with blocking magnets at an end of a rotational dynamoelectric machine according to an example embodiment of the present invention.

FIG. 54 shows another example embodiment of a location of flux returns at an end of a rotational dynamoelectric machine according to the present invention and a flux density thereof.

FIG. 55 shows locations of flux returns with blocking magnets at an end of a rotational dynamoelectric machine according to an example embodiment of the present invention.

FIG. 56 shows a location of flux returns with blocking magnets at an end of a rotational dynamoelectric machine according to an example embodiment of the present invention and flux densities thereof.

FIG. 57 shows a location of flux returns with blocking magnets at an end of a rotational dynamoelectric machine according to an example embodiment of the present invention and flux densities thereof.

FIG. 58 shows a location of flux returns with blocking magnets at an end of a rotational dynamoelectric machine according to an example embodiment of the present invention and flux densities thereof.

FIG. 59 shows a location of flux returns with blocking magnets at an end of a rotational dynamoelectric machine according to an example embodiment of the present invention and flux densities thereof.

FIG. 60 shows a location of flux returns with blocking magnets at an end of a rotational dynamoelectric machine according to an example embodiment of the present invention and flux densities thereof.

FIG. 61 shows a perspective view of wire turn extending through flux returns at an end of a rotational dynamoelectric machine according to an example embodiment of the present invention and flux densities thereof.

FIG. 62 shows a flux view through an S-shaped flux return according to an example embodiment of the present invention.

FIG. 63 shows a flux view through an S-shaped flux return according to an example embodiment of the present invention.

FIG. 64 shows a flux view through a side of a dynamoelectric machine according to an example embodiment of the present invention.

FIG. 65 shows a flux view through a top of a dynamoelectric machine according to an example embodiment of the present invention.

FIG. 66 shows a flux view through a top of a dynamoelectric machine according to an example embodiment of the present invention.

FIG. 67 shows a flux view through an S-shaped flux return according to an example embodiment of the present invention.

FIG. 68 shows a flux view through an S-shaped flux return according to an example embodiment of the present invention.

FIG. 69 shows a flux view through a side of a dynamoelectric machine according to an example embodiment of the present invention.

FIG. 70 shows a perspective view of wire turn extending through flux returns at an end of a rotational dynamoelectric machine according to an example embodiment of the present invention and flux densities thereof.

FIG. 71 shows a perspective view of wire turn extending through flux returns at an end of a rotational dynamoelectric machine according to an example embodiment of the present invention and flux densities thereof.

FIG. 72 shows a perspective view of wire turn extending through flux returns at an end of a rotational dynamoelectric machine according to an example embodiment of the present invention and flux densities thereof.

FIG. 73 shows a perspective view of wire turn extending through flux returns at an end of a rotational dynamoelectric machine according to an example embodiment of the present invention and voltage densities thereof.

FIG. 74 shows a perspective view of wire turn extending through flux returns at an end of a rotational dynamoelectric machine according to an example embodiment of the present invention and voltage densities thereof.

FIG. 75 shows a perspective view of an end of a rotational dynamoelectric machine according to an example embodiment of the present invention and voltage densities thereof.

FIG. 76 shows a schematic illustration of a rotational dynamoelectric machine and wire according to an example embodiment of the present invention and voltage densities thereof.

### DETAILED DESCRIPTION OF EXAMPLE EMBODIMENTS

As discussed briefly above, many investigators have tried various ways of connecting 2 or more homopolar rotors in series to increase the voltage. If the unit has sliding contacts that operate in series, the resistance of the sliding contacts adds, increasing the problem proportionately to its solution. Non-sliding contacts such as a wire physically connected to the rotors do not have the sliding contact resistance losses, but often encounter a different problem.

Because of the Faraday paradox, the magnetic field in many homopolar generators can be thought of as stationary even when the magnets that make the field are rotating. A connector/wire attached to the moving rotor layer moves through that stationary field and therefore experiences a voltage/emf. When the connector/wire passes through the reversed direction returning flux, the voltage created in the connector/wire can be essentially equal and opposite to the emf/voltage created in the rotor-canceling the output of all but one rotor no matter how many are connected in series.

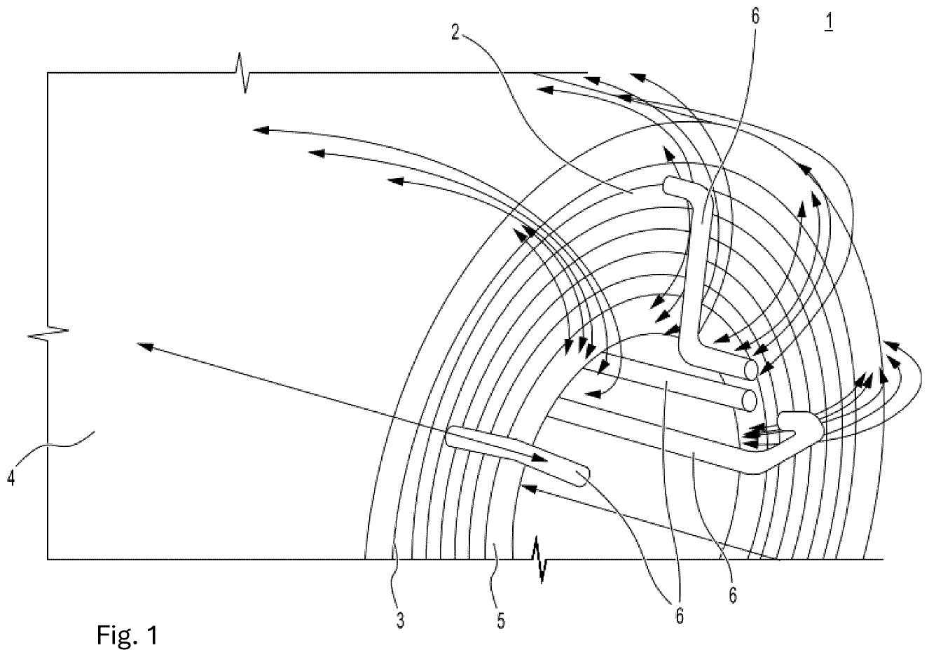

FIG. 1 shows an example embodiment of a novel Faraday paradox drum homopolar machine 1 according to an example embodiment of the present invention. The Faraday paradox drum homopolar machine 1 preferably includes, for example, five cylindrical rotors 2 sandwiched between six magnet layers 3 (e.g., “stator” layers) that define a stationary radial magnetic field, because of the Faraday paradox, the magnetic field functions as if it were stationary even when the magnet layers 3 are rotating together with the cylindrical rotors 2. The cylindrical rotors 2 and magnet layers 3 are preferably housed within a hollow tube casing which includes an outer cylindrical housing/yoke 4, an inner cylindrical housing/yoke 5, and an empty center. The locations of the flux return are shown as gray flux lines in FIG. 1. The drum homopolar machine 1 preferably further includes connectors/wires 6 which are electrically hard connected (e.g., fixedly connected as opposed to sliding connected) to the rotors through, for example, welding, brazing, etc. The connectors/wires 6 are structured to pass through the empty center to connect one axial end of a first one of the rotors 2 to a far axial end of another one of the rotors to link them in series, parallel, or a combination of series and parallel. There are preferably disk shaped yoke end caps that connect the inner and outer cylindrical yokes 4 and 5 on each end (not pictured here).

When this entire apparatus spins axially the stationary flux field does not rotate. As the rotors rotate through the stationary radial field within the cylindrical stack of rotors/magnets that make up the body of the generator, an emf is induced that causes a voltage pushing current toward one axial end of the rotors. (There are other embodiments in which the magnetic field polarity around the different rotors are in different directions, making the EMF towards alternate ends of the different rotors. For simplicity the below discussion will focus on the variants in which the EMF in all rotors pusses in the same axial direction.

In motor applications the rotor is best considered as a series of axial conductors, insulated laterally from each other. These are described in detail in related application. In generators, a wire/electrical connector picks up the current from one rotor axial end, passing, perhaps, through the axial center of the machine to connect with a different rotor layer on the far axial end. (There are also other routes for the wire, but through the center is discussed for minimal field interaction.) But for a single problem, this would be an ideal way of connecting the rotors in series to add the voltages.

The problem, as shown in FIG. 1, comes from the wires/connectors 6 spinning with the cylindrical generator body. As the wires 6 are dragged through the two reverse flux fields (one on each axial end of the cylindrical body), a substantially equal and opposite EMF is generated in the wire 6 effectively canceling the net current flow from the additional rotor layers 2.

The origin and insertion of each wire 6 is at the rotor 2 in the center of both sides'stator 3 flux loops. The path the wire 6 travels, of necessity, crosses the walls of both flux loops. Simply re-routing the wire 6 cannot solve this problem. There is no alternative path for the wire 6 that does not cross the “flux box” walls that surround the wires' 6 origin and insertions at the axial ends of the rotors 2.

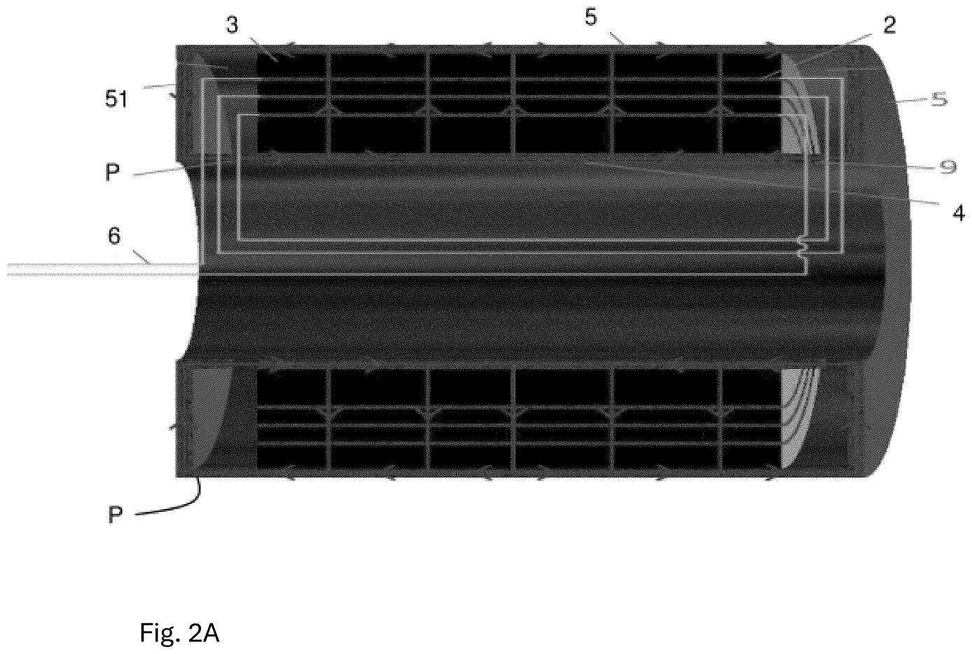

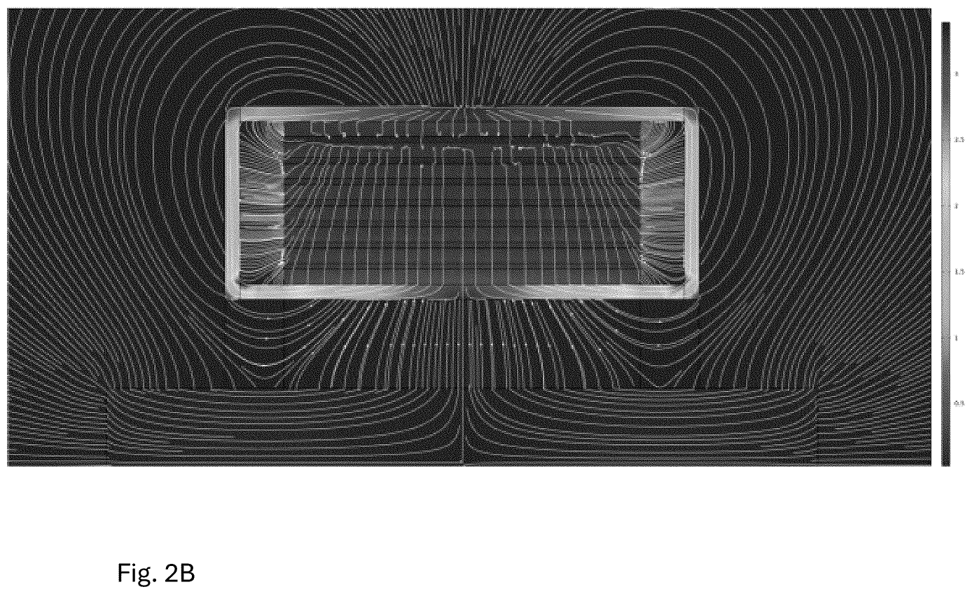

FIG. 2A shows a cross section of an example embodiment of a dynamoelectric machine of the present invention in which flux paths P (indicated with directional arrows) make two taurus shaped closed ‘boxes,’ each of which surrounds one end of the rotors 2. The wires 6 connect the rotor layers 2 in series. The wires/connectors 6 pass from within the center of one side's flux path box, coursing through the two flux boxes'walls to get to the center of the other flux box to reconnect with the rotors 2. The problem area is depicted where the wires 6 cross the flux lines of the path P. Each time the wire transects the return flux path it experiences an opposite voltage induction in the wire 6 which cancels out the addition of half of an additional rotor's voltage. Because the wire 6 transverses two flux box walls, the entire voltage of the additional rotor is effectively canceled.

In FIG. 2A, the layered stator magnet layers 3 create magnetic flux that passes radially through the rotor layers 2, in this case, toward the periphery of the cylinder. The return flux is picked up by outer yoke 5 and transmitted through to the closest sidewall 51 and back to the south pole of the magnets 3 via the inner flux return cylinder 4. The wires/connectors 6 pass through a hole in the inner flux return 4 at points 9.

The flux path P bifurcates into 2 taurus shapes with closed box rectangular cross sections. The interior of the flux path box-like cross section is where the wires 6 attach to the rotors 2. At points 9 the rotating wires 6 transect most of the stationary return flux, creating reverse EMF. There are many other permutations and shapes for the parts or system, but in function they are analogous to the example shown in FIG. 2A. Because flux is always a closed loop and the connectors 6 pass through all the return flux, an equal and opposite EMF voltage is created in the connector as is created in that rotor 2.

FIG. 2B depicts flux returns with side wall end caps, with the magnetic flux creating closed loop “boxes” that encircle each end of the rotors and that the electrical rotor connectors would have to pass through the walls of both boxes to connect with the opposite end of a second rotor.

As shown in FIG. 2A, there is no way to get from inside one flux box to the inside of the other red flux box without crossing the walls of each box and when the connectors 6 cross the return flux and opposite voltage is induced. Note that, even though it is not shown in FIG. 2B, the inner magnets of the stator layers 3 should be stronger than the outer layers in proportion to their circumference and the inner flux return yoke 5 should be thicker and/or more permeable than the outer flux return yoke 4 in the same ratio.

The inventor of the present disclosure has discovered a variety of novel alternative solutions to the arrangement of FIGS. 1-2B which offer different efficacies in solving the flux return reverse voltage problem. Example embodiments of the present disclosure discussed below which correspond to the variety of novel alternative solutions can be combined and altered to adapt to other homopolar configurations without losing the core inventive concept.

Common to the below example embodiments, novel arrangements of magnets are specifically shaped and positioned to function as flux returns to manipulate and help direct the flux return field of the stator layers 3 to minimize, eliminate, or even reverse the backward EMF generated when the connectors travel through the stationary return flux as shown in FIGS. 1-2B. To start, some simplified Finite Element Analysis (FEA) diagrams to show various permutations of the novel solutions will be presented.

We will start with 2D studies to look at intrinsic parameters, then proceed to 3D studies in a simulation of the actual working environment. In the 2D studies the stator return flux field corresponds to two large magnets, each with north to the right, stationed on either side of approximately S-shaped flux returns.

A first example embodiment of the present disclosure is an ‘original S’ flux return which has the FEA demonstrated ability to turn the flux first 180 degrees backwards, giving the effective angle for positive induction of voltage in the wires, then turning the flux back 180 degrees to continue its path. That structure also focused its effect on the portion of the return flux closest to, and directed at, the wire.

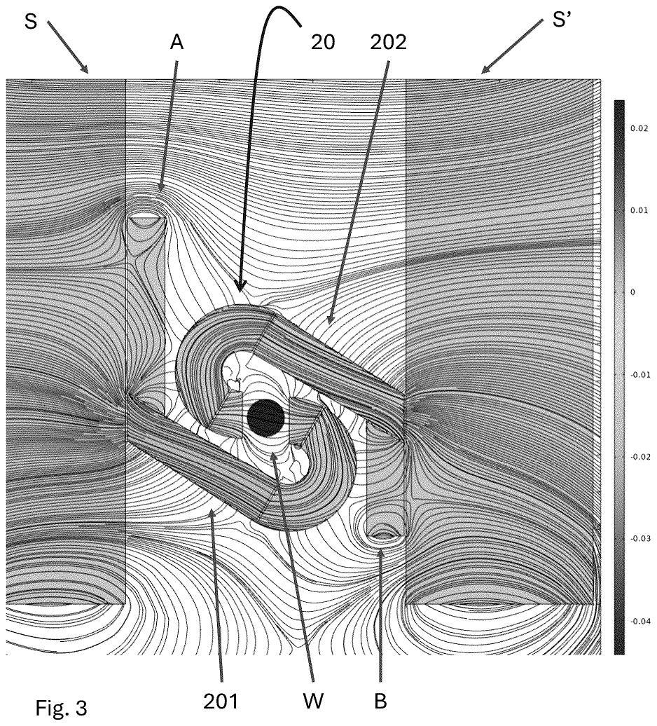

FIG. 3 shows a permutation of the original S structure flux return 20 with blocking magnets A and B at left and right sides adjacent to the stator S and S′. It was able to turn 325 mV of deleterious induction into 724 mV of advantageous voltage. This original version is very effective but could still be improved upon further in manners as discussed below.

Several factors combined to make that first structure function sub-optimally. The tightness of the switchbacks 201 and 202 adjacent to the armature windings W inadvertently provided a permeability enhanced straight shot highway for some of the flux to just pass through the winding W of the armature directly in the wrong direction, rather than take the needed long, tightly convoluted S path. The curves of the switchbacks 201 and 202 were packed so closely together the flux just jumped straight across like a hiker cutting through a forest between two parallel trails.

The extreme convolutions in the switchbacks 201 and 202 made the flux return 20 be less effective at turning the stronger flux around the 180 degree turns, and made it too sensitive to being overwhelmed by overflow/cut through flux. The overflow flux vector-added to the itinerant convoluted flux to block it from inducing good voltage.

The final reason this version did not work as well as possible was that it directly draws the powerful flux out of the stator side wall S and S′, instead of drawing the much weaker flux from the surrounding field. The powerful side wall flux thus overwhelmed the system.

The end result was that although FEA in FIG. 3 shows that the classic S structure could work very well in most permutations, it was too easily overwhelmed in some physical models.

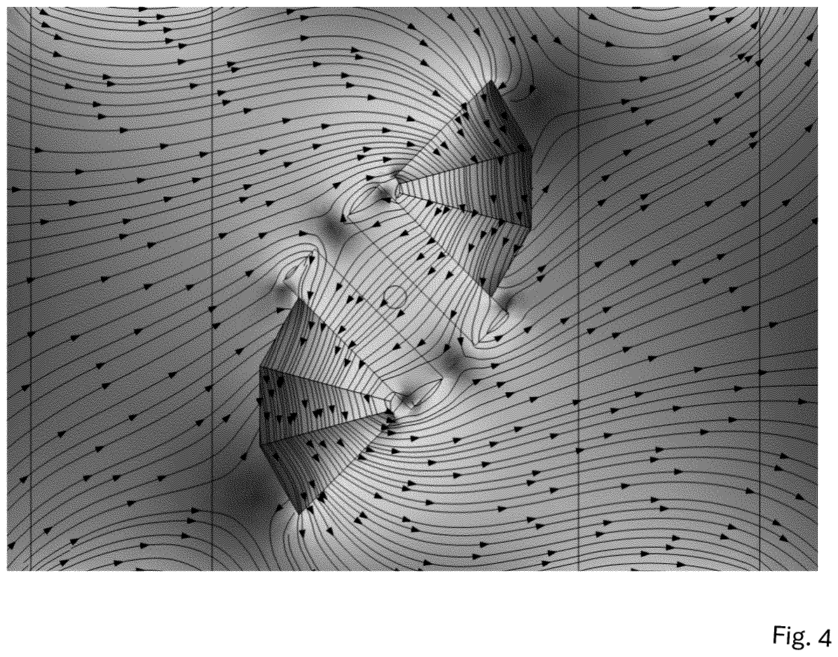

To address the above problems in the embodiment of FIG. 3, next we investigated the primitive ‘S 2.0’ version seen in FIG. 4.

FIG. 4 shows a version of the S 2.0 flux return structure with no refinement and basic parameters. Note how well the structure turns the flux in the S path, but that there is opportunity for improvement.

In this example embodiment, the switch back turns were cut back so they did not fold over on themselves and inadvertently define portions where flux could simply jump and avoid passing through the switch back and overflow straight through. The cut back curves also draw flux from the weaker air gap flux field rather than straight from the powerful field in the sidewall preventing overload. True, lateral flux could enter the wires' gap in this structure, but that would vector add with the greater amount of flux coming in laterally through the path in a way that didn't prevent function. The turns were also not as sharp. This solved most of the problems of the original S, even in the tight confines of our physical generator.

In this primitive model there are many sub-ideal efficiency losses. The ideal gap flux orientation would be 180 degrees back toward the left, but half of that angle has been sacrificed.

Disadvantageous flux can enter the gap skewing the left hand side gap flux. The bends create a weak field on the inside of the curves and a strong field on the outside. The strong field on the outside (convex side) of the intake discharges most of its flux by leaking to the right instead of pushing it around the corner and through the wire gap. The distal outflow has a large airgap at the end that acts like a flux resistor, limiting the flow through gap flux. The efflux side also draws in extra flux through its convex side, limiting some of the input side flux ingress.

This is called a primitive version because the parameters of every angle, thickness, width, length, strength, etc. were just educated guesses at what may be effective. However, even without any refinement, it functioned well in FEA and with about 40-60% efficiency in the vertical section of 1 physical mode. This study takes each aspect of the primitive S 2.0 shield individually and refines its parameters, then it combines the advantages, while compensating for their possibly disadvantageous effect on each other.

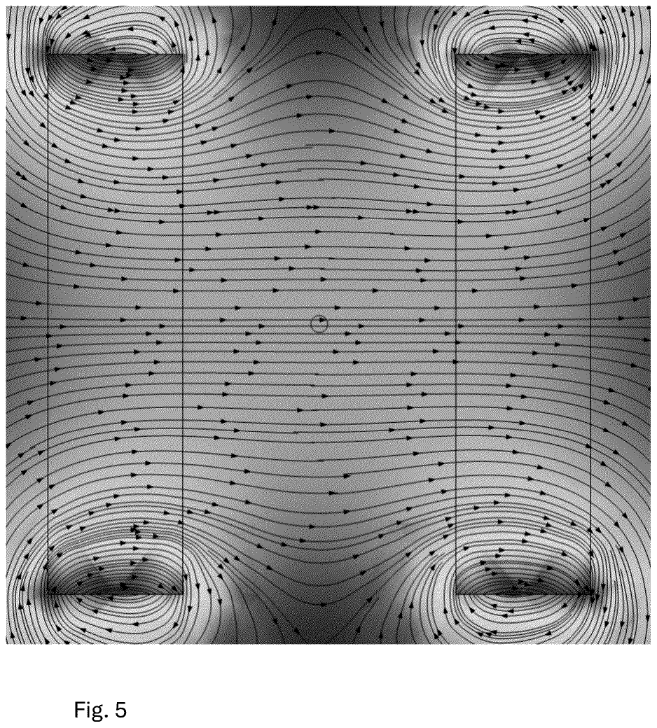

FIG. 5 shows a baseline Stator and Winding arrangement as would be provided by an end of a dynamoelectric generator according to an example embodiment of the present disclosure. This baseline includes a 0.125 inch diameter, 10 cm long wire moving between two large (North right) magnets. A direction of motion of the generator would be upwards with in FIG. 5 at a velocity of 20 m/s. The magnet strength corresponds to 300 mT for both the field (e.g., stator) and shield (e.g., at the opposing ends of the switchbacks sandwiching the wire) magnets or iron portions as a starting point. The unshielded wire moving upward in the stator field of FIG. 5 has −133.3 mV (negative/bad voltage)induced.

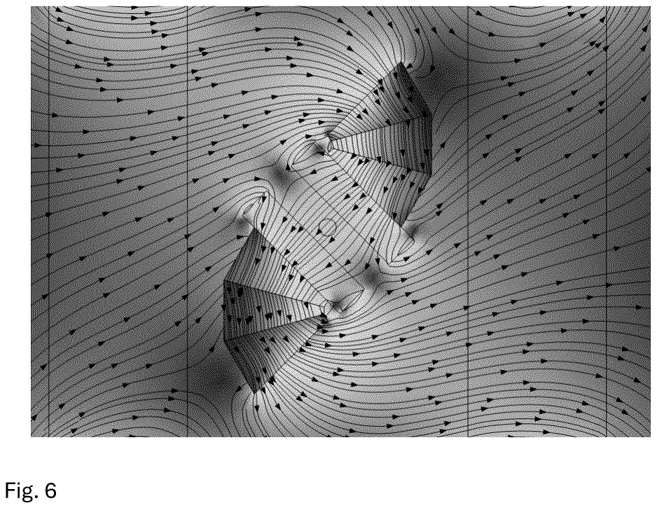

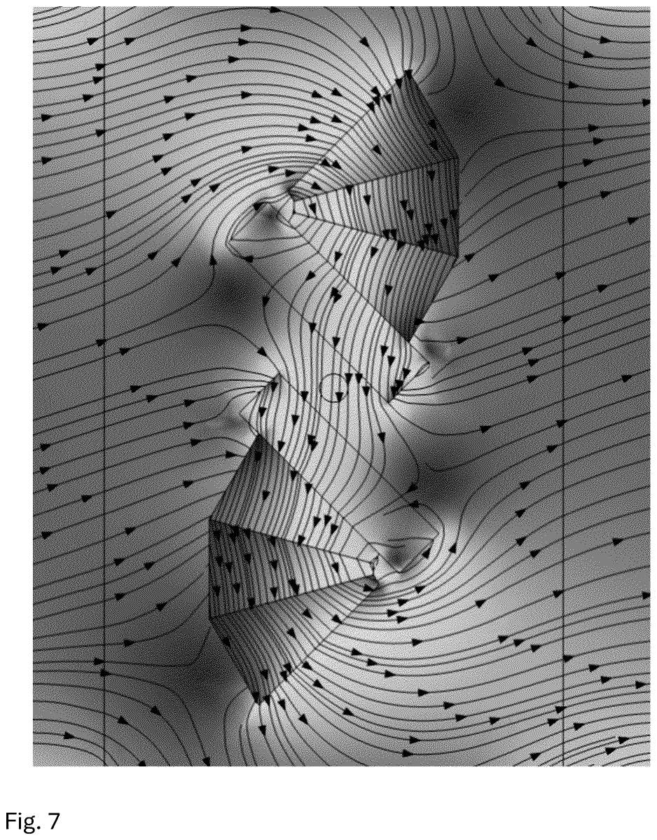

FIG. 6 depicts an example embodiment of the primitive S2.0 around a wire moving upward in a simulated stator field. Here the induced voltage is now positive and advantageous at 232.7 mV and the gap flux in the wire was 120 mT. This is excellent, especially as the device is still primitive and unrefined. Even though this primitive structure was entirely unrefined, it is effective enough to get real power past the return flux in the physical model.

A first refinement study was performed to look at the effect of skewing the gap flux in either direction by shifting the top and bottom portion of the shield relative to each other along the wire air gap's axis. Starting with what we knew would be disadvantageous.

Shown in FIG. 7, the top switchback part was moved 0.2 inches toward the left. We knew this would cause the gap flux to skew to a more disadvantageous angle, dropping the induced positive voltage and reducing the effective area for the wires.

In FIG. 7, the intake and output sides have been translated laterally in the plane of the gap to skew the gap flux, in this case, in the disadvantageous direction. On the plus side, this increased the wire's gap field strength by putting strong areas of wedge magnets closer together. This drew some of the flux that was leaking out the intake convexity into the wire gap so the field strength went from 120 to 160 mt. This configuration also pulled the concave sides of the curves away from the field magnets reducing some leakage. On the negative side, it slightly shortened the efflux air gap and the gap flux lost all leftward direction.

As expected, the net result was a near complete cancellation of the negative induction, and it surprised us by granting 41.0 mV positive induction. A positive lesson is the opportunity to improve the gap field strength. Ways to manifest that without the other skew disadvantages include, but are not limited to, using blunt acute end wedges, using stronger central magnets, and/or differential strength magnet material with stronger material concentrated at the narrow end.

Next we show shifting the magnets in the advantageous direction. We moved them incrementally to find the best position to balance skew angle and field strength. We thought that the weakening field would offset the improved gap flux angle sooner, but the angle of the flux was much more potent than the loss of field strength.

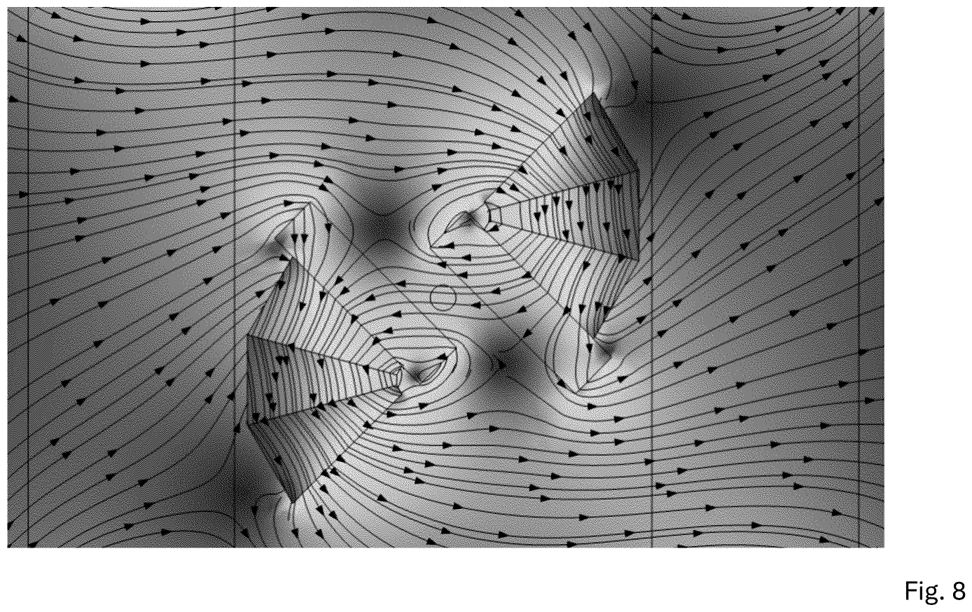

FIG. 8 shows a Primitive 2.0 example embodiment of the present disclosure with sufficient positive skew to make the gap flux point 180 back at its origin. While the gap field direction is now ideal, the field strength was reduced to 110 mT. The reduction in field strength was from the weak ends of the magnets interacting and the skew increased the perceived distance between the magnets. The strong side of the inlet magnets simply discharges all that useful flux into the air. Note also that the wedge points are making flux return loops instead of pairing with the big magnets. This configuration also puts the concave side of the wedge magnets closer to side walls increasing leakage and efflux airgap. There was also a much smaller area for the ends of the armature wires to pass through.

310.8 mV was induced in the arrangement of FIG. 8, showing the advantageous gap flux orientation was so effective it overcame the multiple other problems. This underscores the importance of a good skew angle in the final structure. While this was a 70 mV advantage over the centered version, increasing the right side convex curve gap or adding/reshaping a blocking magnet would possibly make the positive induction greater. Perhaps shaving off the right most portion of the concave side of the intake of a switchback would do the trick. Just using less wide, more blunt nose wedge magnets might be sufficient.

Manipulating the skew angle makes the S 2.0 much more powerful. Pairing this improvement with the above and below mentioned ways of addressing the weaker gap field and less room for wires is necessary to see the full effect, but even without those fixes the skew alone added 33% more positive voltage

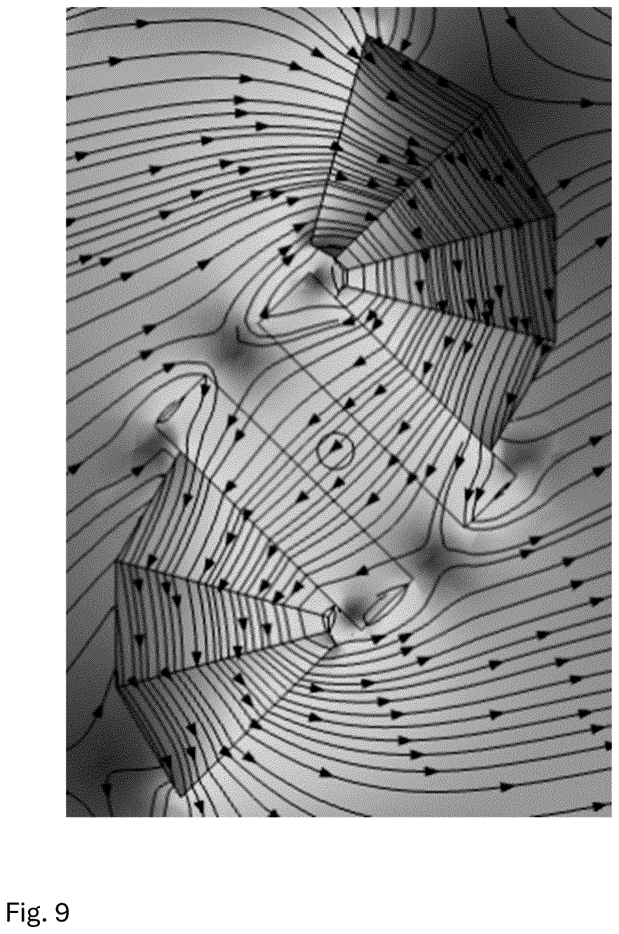

In the example embodiment of FIG. 9, we considered that the intake face was pointing away from the deleterious flux that is directly to the left of the wire, and enters the wire gap between the opposing faces of the switchbacks. We added a 4th 30 degree magnet wedge to the intake switchback, which added to the total magnetic strength of the ‘S’ path but only added just 12 mt to the gap field(132 mT).

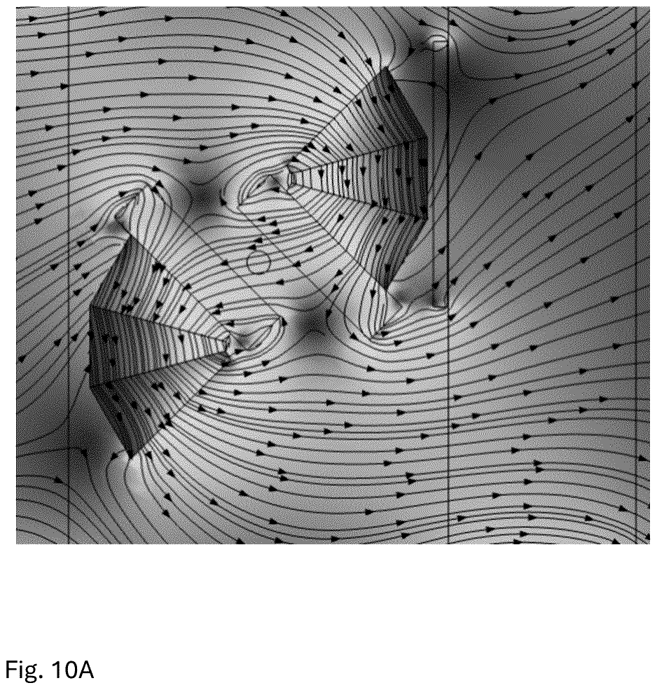

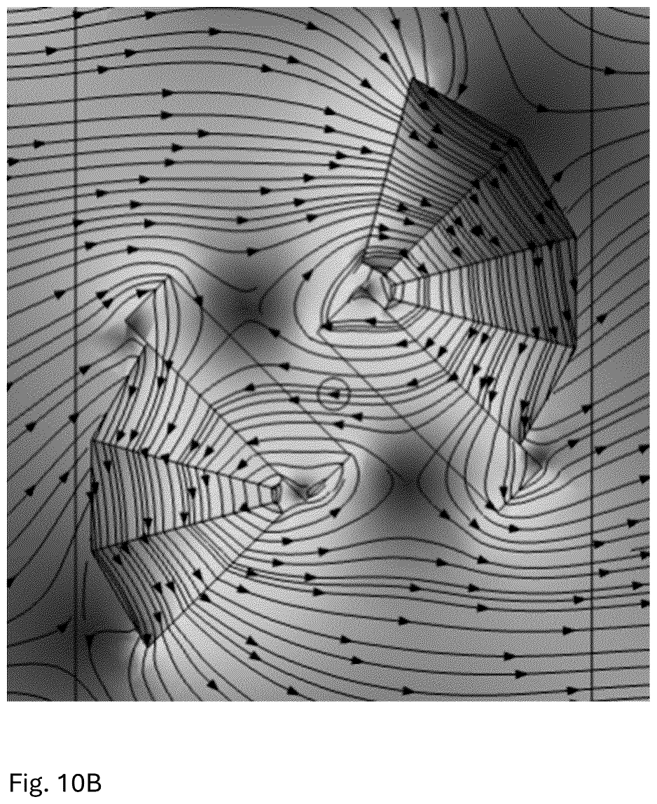

In FIG. 10, an example embodiment of the present disclosure includes an added extra 30 magnet wedge to the intake side. This structure added 12 mV to the positive induction, totaling 252 mV, which wasn't much. The colormetrics show why there was so little benefit. Adding the extra magnet clearly improved both the amount of flux being pulled in, and direction from which the flux was being drawn (Grabbing the portion that would have gone to the center wire.) It also made the influx section much more powerful: see how much of the influx section is red. The reason there was so little additional induction is the extra flux exited the convex side of the intake rather than going around and through the gap. (This is a large portion of the reason why the physical test results of the primitive model were modest.) The flux took the short way out for 2 reasons. There isn't enough air gap at the convex side of the intake, and of lesser significance the effluent half was already taking much of the flux it could with the flux leaking into its convex side. Adding more intake without increasing the outflow is analogous to trying to push a rope instead of pulling it.

This could be fixed by making more air space lateral to the intake's convex side by shaving the concave side down, changing the shape of the curve to a flatter convexity or pushing the flux return further away. Using a blocking magnet would also help. Function could also be improved by making the effluent better able to handle more flux and by using a blocking magnet at its convex side. Additional benefit could come from increasing the strength of the central magnets as this would even out the flux in the wedges somewhat. Another way would be to make each magnet or group of magnets slightly stronger with the weakest at in influx and the strongest at the outflux.

In the next study of FIGS. 10A and 10B, we took the imbalanced strong intake/weak efflux model and skewed it maximally. Here we would expect the gap field to drop from increased convexity leakage plus the weak sides of the magnets (e.g., shield magnets) opposing each other over the gap. We would expect the induction to rise more than the gap field dropped due to the better gap flux angle.

FIG. 10Aa shows Skewing the gap to bring the flux to 10 degrees off 180 back.
Position: −0.15
Field strength: 110 m T
Voltage: 307.29 mV

FIG. 10B shows skewing the intake with an extra magnet wedge portion in its switchback so the gap flux reached 180 degrees back. We got 131 mT field in wire (21 mT improvement over non skewed) and 339.0 mV induction (29 mV improvement over non skewed) which is interesting, but doesn't add much new structure information. If we were to fix the efflux barrier and convexity leak a better induction would be expected.

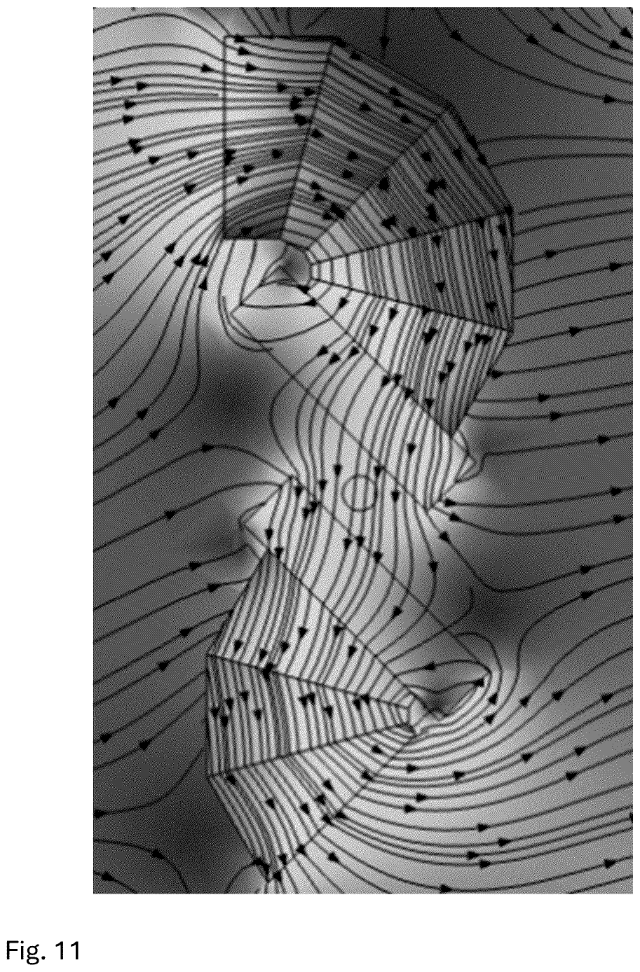

As shown in FIG. 11, skewing the switchback in it the other direction shows an expected increase in the gap field to 164 mT from the strong sides of the wedges interacting and the induction was only 51.8 mV due to the poor gap field direction. Adding another intake magnet made nearly no change as expected.

FIG. 11 shoes an example embodiment in which skewing the gap in the disadvantageous direction strengthened the gap field and dropped the positive induction: 167.8 mT, 62.5 mV

We needed to fix the outflow first to see the benefit of further improving the inflow. Note how red the inflow side is and how yellow is the outflow side. Before fixing the outflow, a second additional magnet was added to the intake of the unskewed version (e.g., FIG. 9) also. Again, the intake function ability is additionally improved, plus it drew still more flux from the problem area left lateral to the wire, keeping that flux out of the gap. And again, while the intake was much more powerful the majority of the extra flux just leaked out the concave side instead of going through the gap.

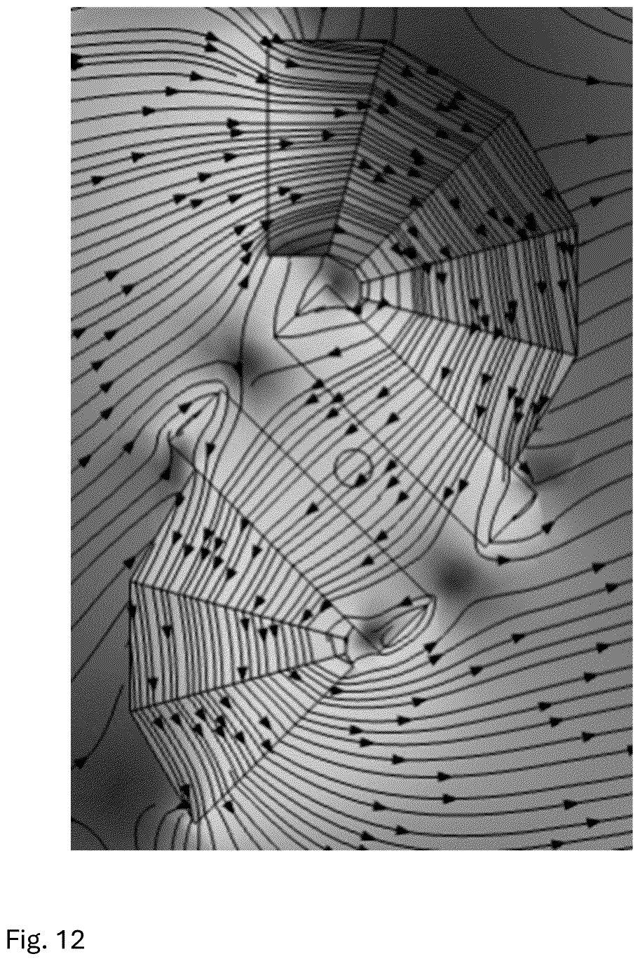

FIG. 12 shows adding a second extra wedge to the intake without improving the outflow gives a diminished return. The gap flux only went up to 140 mT (up 8 mT) and the induction only went to 270.7 mV (up 18 mV.) This underscores that the improvements need to work together to realize the potential gains. While the intake and gap flux angle were improved, but the majority of potential improvement was not realized because the intake's flux leak and the relative blocking of the outflow. This shows the importance of considering how improvements work together, after trying to see how they work in isolation.

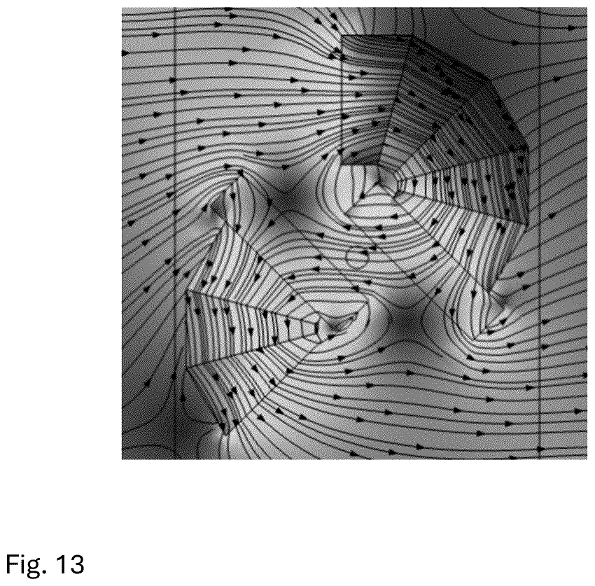

FIG. 13 shows a further modification in which advantageous skew is added to an out of balance S example embodiment of the present disclosure. The gap field was 145 mT, but the voltage had an impressive 100 mV increase to 370.2 mV. Once again, even with the outflow issue still in place, skew is very important.

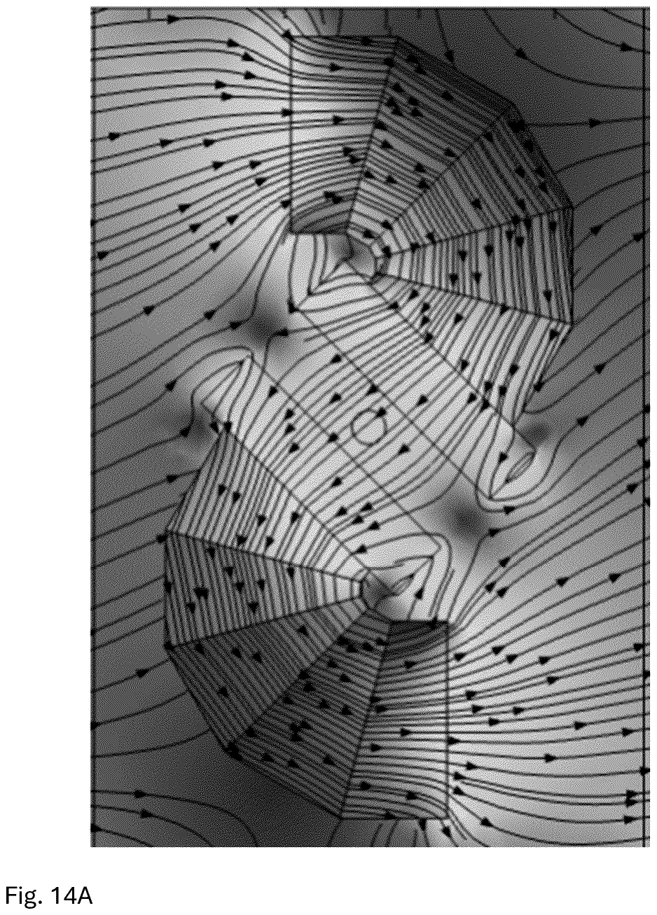

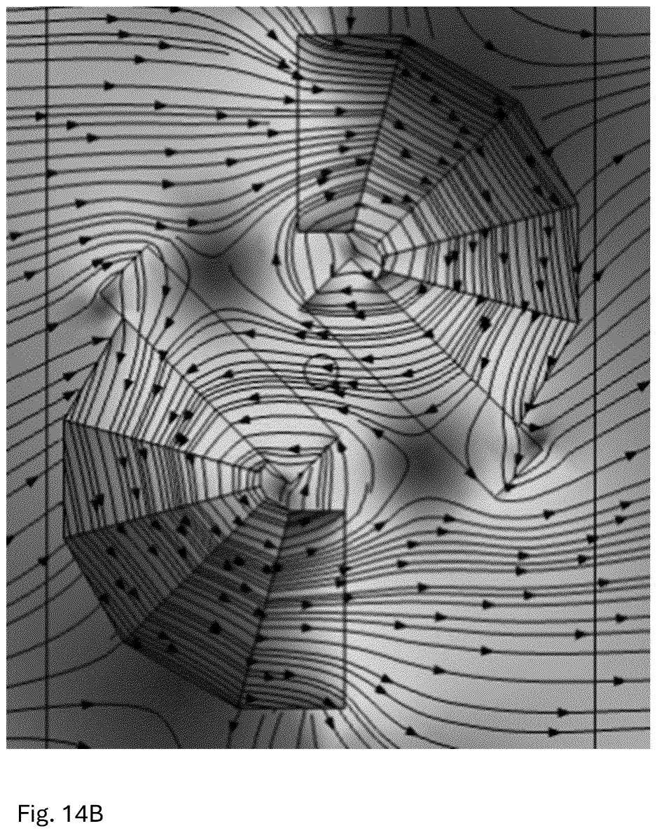

FIGS. 14A and 14B show 5 magnets on both the intake and outflow sides. All 300 mT. When there were 3 magnet wedges on the switchback of both sides of the flux return, the gap flux in the wire was 120 mT and the induced voltage was 232 mV. Adding 2 magnets to both sides as in FIG. 14A brought the gap field up to 156.2 mT, and the induction to a robust 310.1 mV

FIG. 14B shows an example embodiment including skewing the balance 5 segment version. The field strength went up to 172.8mT, and the voltage increased to 431.2 mV Balancing the intake and outflow increased power by about 16%, but there is still considerable resistance from the outflow air gap.

In next example embodiments, we add more pull to the outflow side than push from the inflow side. First we will add one or more distal iron portions to take out the efflux airgap, then add another out flow magnet, then shape the iron.

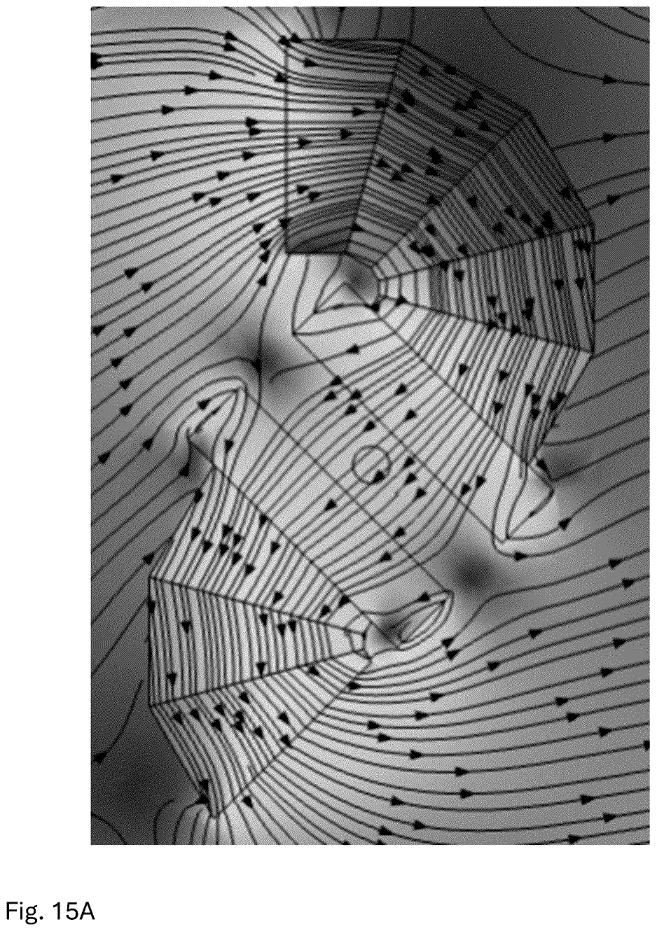

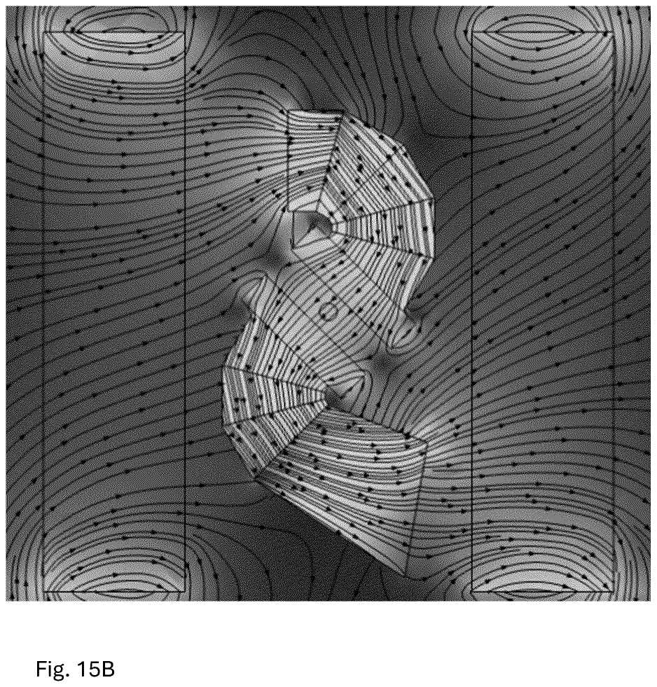

As shown in FIGS. 15A and 15B, the gap field and outflow are improved by adding some iron portions at the discharge end. This decreases the outflow air gap. Judicious use of iron has the advantage that it acts as a magnet whose strength and direction is determined by the exogenous field. This makes it a variable, adaptive component to match strength and direction of the stator return flux field. In this study there is still an imbalance between the number of intake and outflow magnets, but the iron in the field becomes a magnet to create some balance.

FIGS. 15A and 15B show the addition of iron portions to the tail of example embodiments of the present disclosure.

FIG. 15A shows an example embodiment without tail iron in which the gap flux was 140 mT and the induction was 270.7 mV In FIG. 15B, iron is added to increase the gap field strength to 167 mT, and the voltage increased to 311.93 mV with this primitive iron portion.

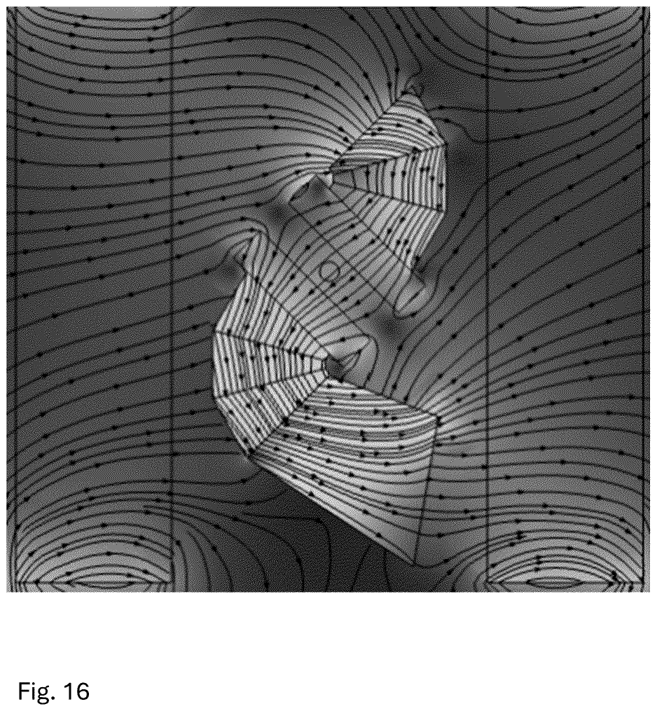

FIG. 16 shows a Tail iron portion added with 3 magnet wedges on influx and outflux switchback sides of the flux return. Field strength: 140 mT, Voltage: 281.91 mV. Note the efflux has more field strength than the intake. The intake is leaking out its convex side and the outflow is leaking in its convex side. This will be addressed in later studies.

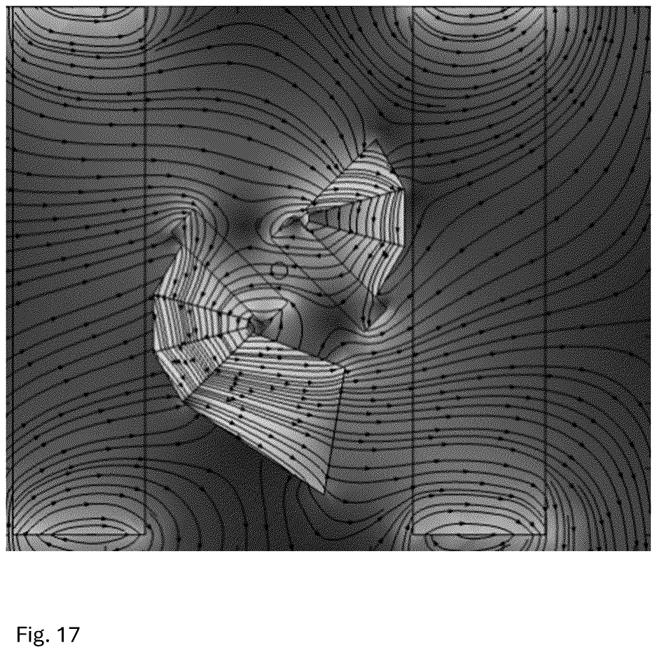

Putting skew on this example embodiment is shown in FIG. 17 in which iron is added to the efflux tail end. Field strength: 145 mT, Voltage: 365.43 mV. Note there is a lot of convex leakage in both the influx and outflux switchback and very little field strength in the magnets, but again the improved gap field direction was potent.

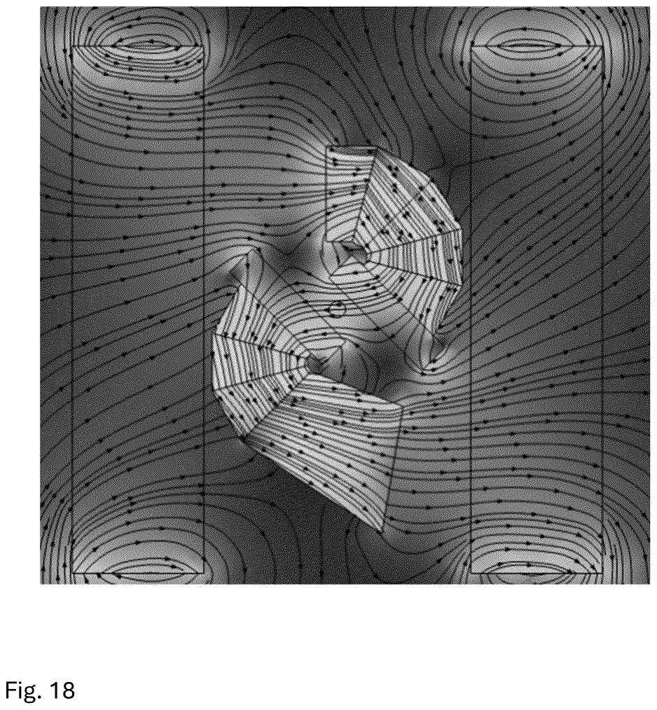

In FIGS. 18, 2 more magnets were added to the influx switchback side and a skew in the gap was added to the iron ended example embodiment. Field strength: 173 mT, Voltage: 439.73 mV. This is a big jump for adding 2 intake magnets. The improved efflux is unmasking the influx advantage. The rope is being pushed and pulled. This would be still better with still more efflux magnets, with the iron reaching almost to the right stator, and with blocking magnets at the convex sides.

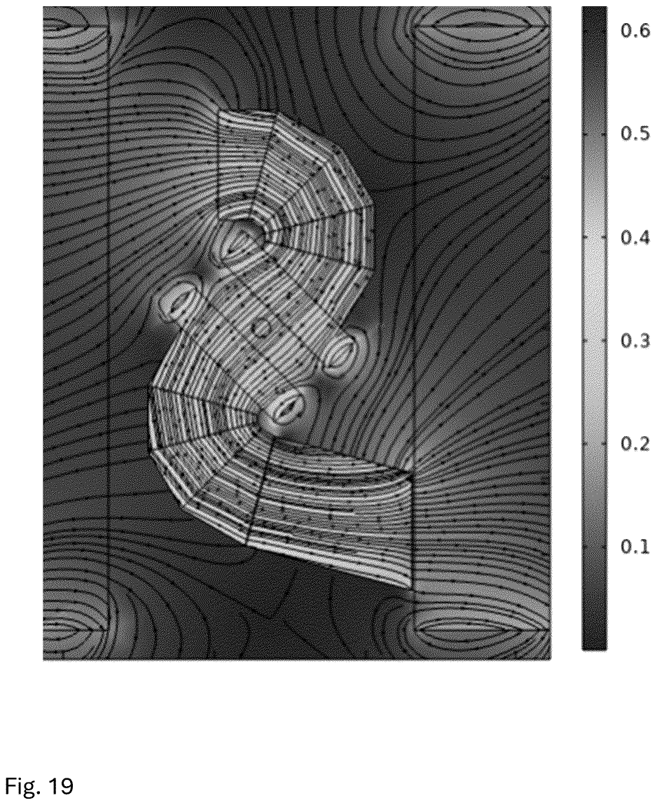

FIG. 19 shows an example embodiment in which the iron reach all the way to the edge of the stator so there is no efflux airgap. In FIG. 19 the iron has been improved by lengthening it and changing the distal angle. It includes 5 magnets on entry, 4 on exit with iron extending to the outer magnet. No skew, 45 degree gap. The gap field was now 256 mT and the induction was 479 mV.

In the next Example embodiments, the central magnets or iron portions are thickened without changing their power. Iron and 2 upper magnets are added. There is less skew because there is less room for lateral movement. This lowers the efficacy and is a variable that needs consideration in comparing study results.

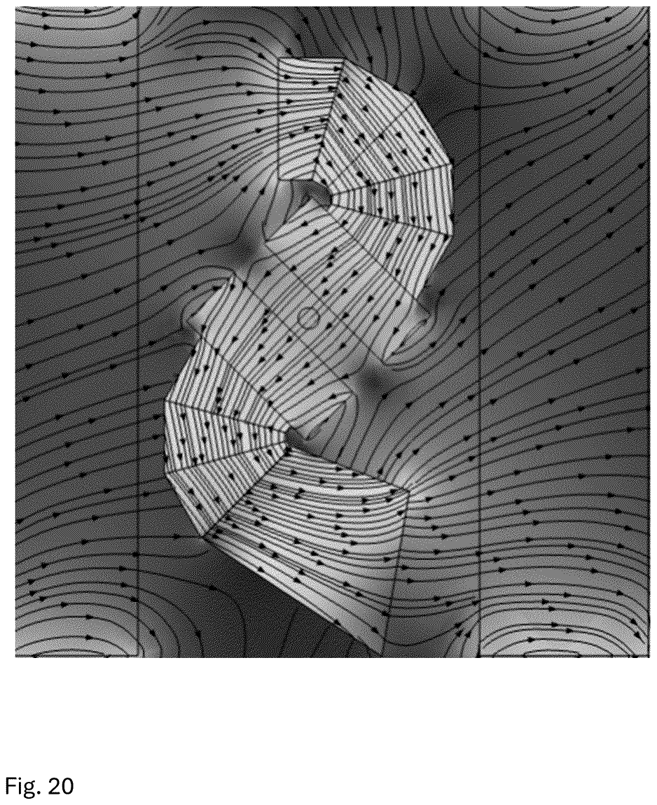

FIG. 20 shows thicker central magnets (or iron portions). field strength: 167.3 T Voltage: 301.8 mV. Note that the gap field and the field in the influx and efflux curves becomes more homogenous.

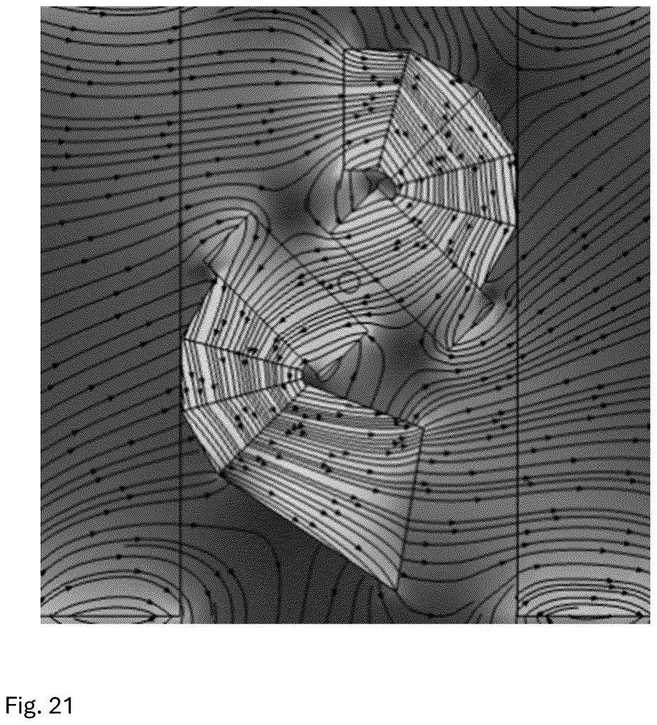

FIG. 21 shows an example embodiment in which slightly thicker central magnets are provided in a slightly skewed 5 intake, 3 discharge model with the less effective iron. Field strength: 170 mT. Voltage: 407.51 mV.

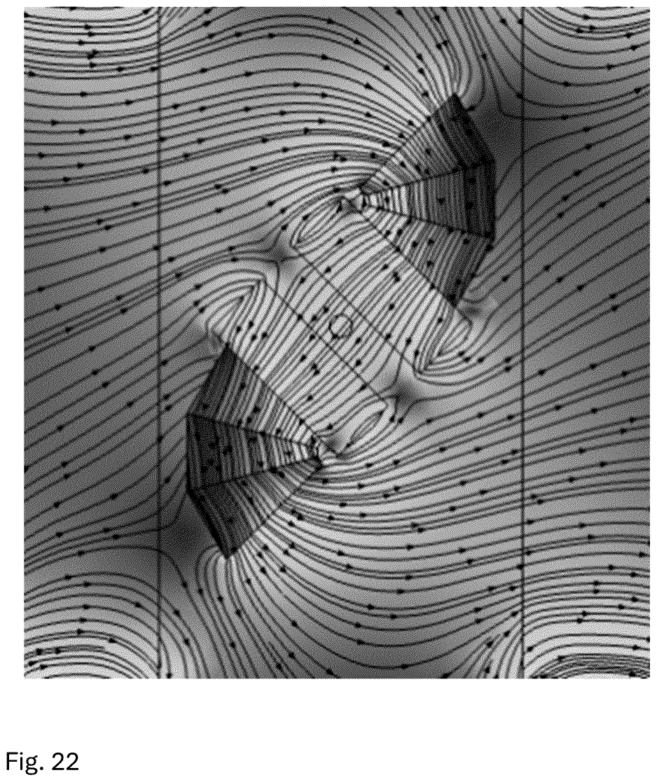

FIG. 22 shows thicker central magnets, 3 wedges on both sides and no efflux iron. Position: 0, Field strength:132.28 mT, Voltage: 229.7 mV.

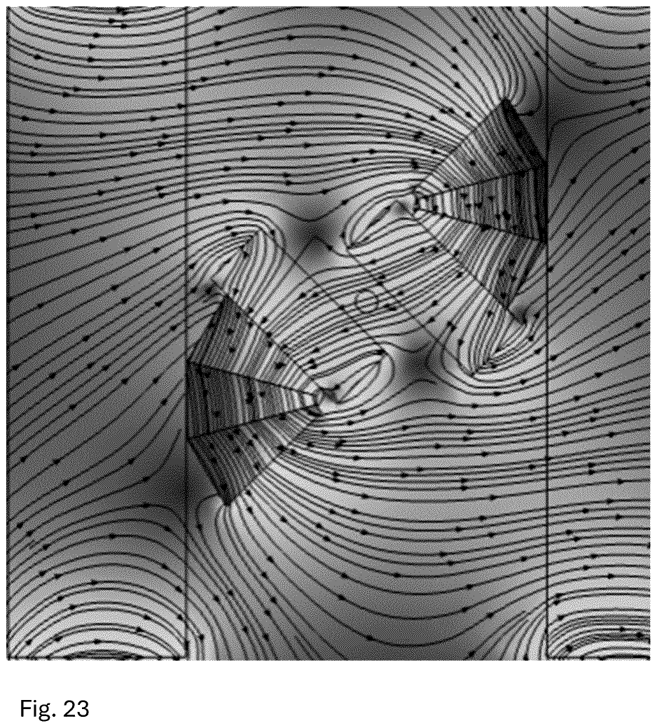

FIG. 23 shows thicker central magnets skewed and 3 wedges on each side with no efflux iron. Field strength: 124.28 mT. Voltage: 309.7 mV.

In the next example embodiments, we make the 2 center magnets stronger without making them thicker. The imbalanced intake and the no iron outflow were used in the following example embodiments. The center magnets were made to be 600 mT.

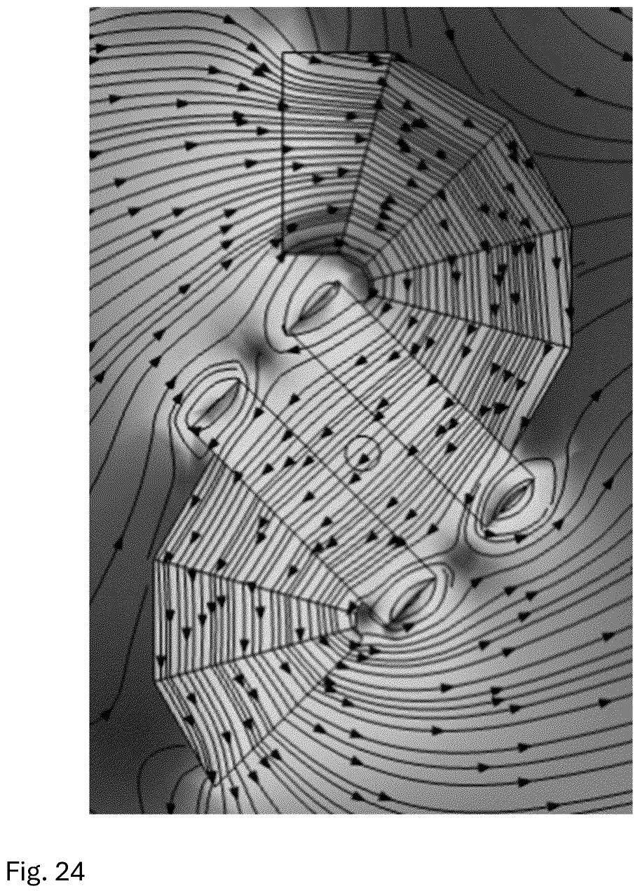

In FIG. 24, the center magnets are stronger, again we see more homogeneous flow and gap field and now less convex leaking on both the intake and efflux sides. The gap field increased to 220 mT, and the induction went up to 422.4 mV. There are several things to note here. The increased strength of the central magnets lessened the difference in strength of the narrow end of the wedges compared to the wide ends. The gap field did not rise as much as would have been expected. It only increased by 60 mT even though its flanking magnets went up by a combined 600mT. The voltage went up much more than the gap field also, suggesting a field measurement threshold adjustment as the color is yellow.

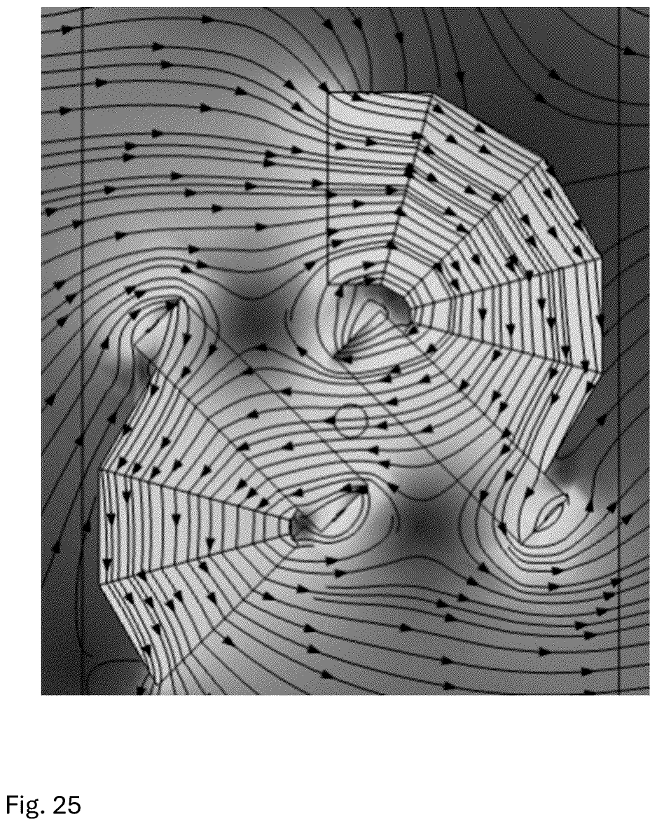

FIG. 25 shoes including a skew added to the center magnets, an uncorrected outflow model made the field 235.5 mT and the output a very impressive 602.41 mV. Note the orange is gone from the intake. It is noted that there seems to be globally lower flux and that more of the intake flux is wasted, yet the result was excellent induction.

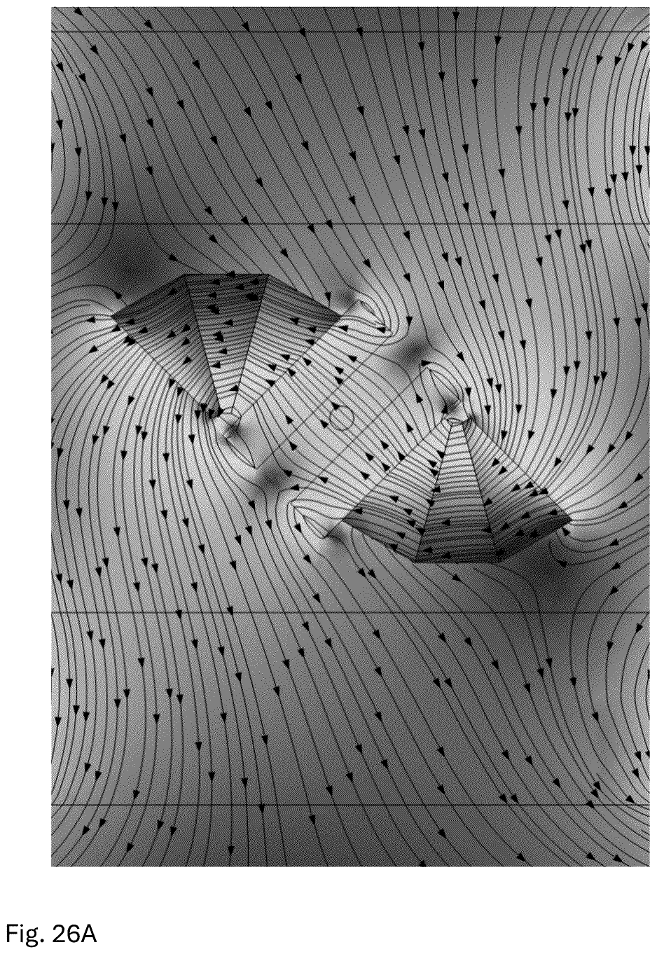

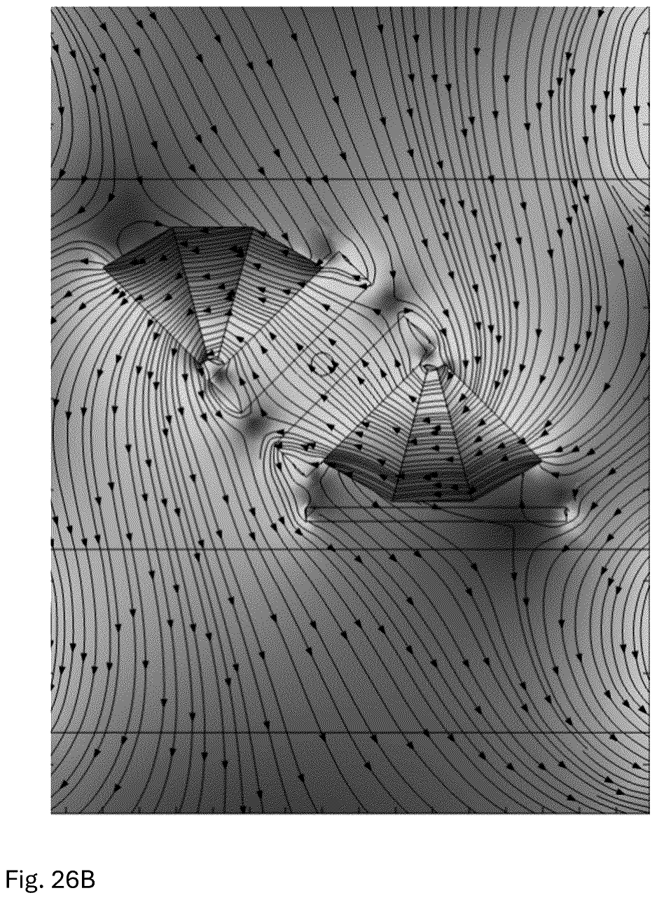

The next example embodiments include adding a single, thin blocking magnet to the intake's convex side. FIG. 26A shows an example without a blocking magnet, and FIG. 26B shows a blocking magnet or blocking iron portion to the right of the intake curve. Without the blocking magnet, induction was 232.7 mV and the gap flux in the wire was 120 mT. With the blocking magnet induction was 239 mV and the gap field seemed to stay the same at 120 mT.

The next example embodiments include increasing a strength of 1 outflow magnet and 1 inflow magnet, then reducing it and increasing the adjacent magnets. This showed that stronger center magnets had the most beneficial effect.

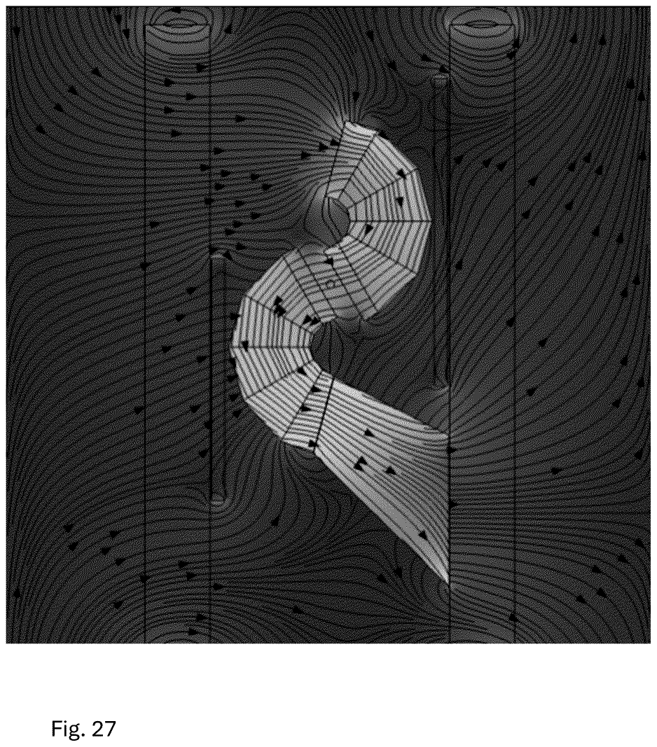

FIG. 27 shows starting with the first and last magnets, increasing their strength up to 500 mT. 228.88 mT. 553 mV.

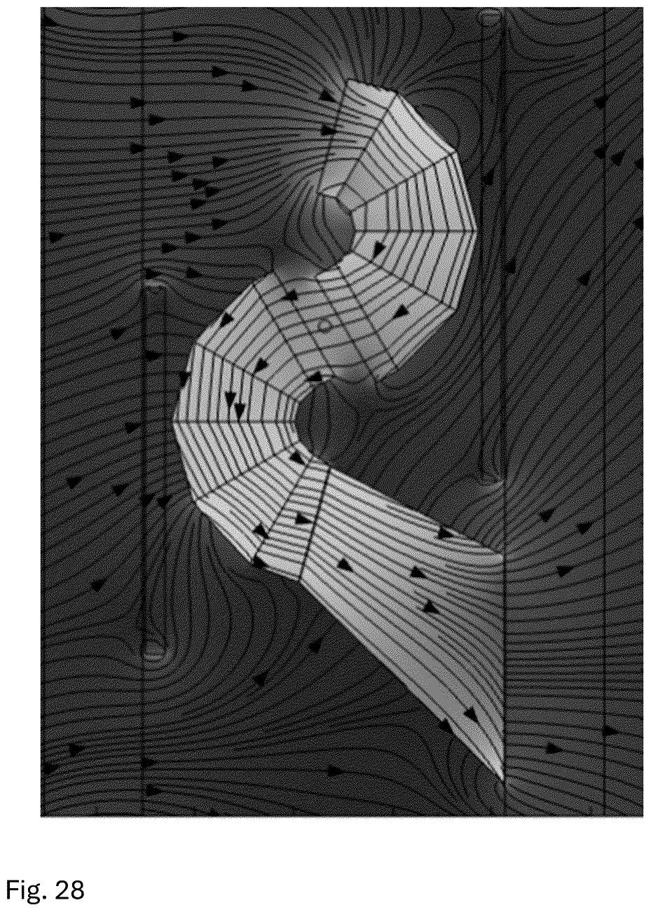

FIG. 28 shows increasing a strength of the second and eleventh magnets only, and including blocking magnet or blocking iron portions. 233 mT. 561.39 mV.

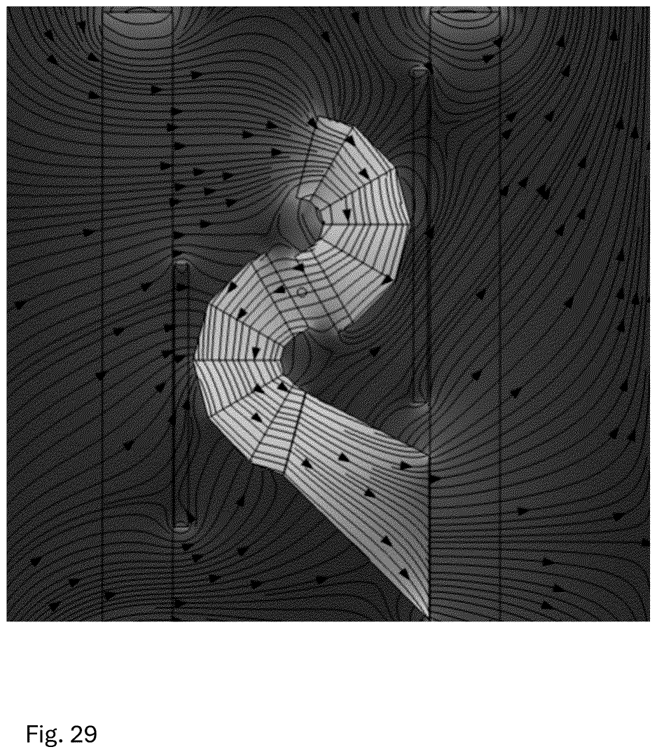

FIG. 29 shows again increasing the strength of the 3RD and 10TH magnets only. 236 mT. 570 mV.

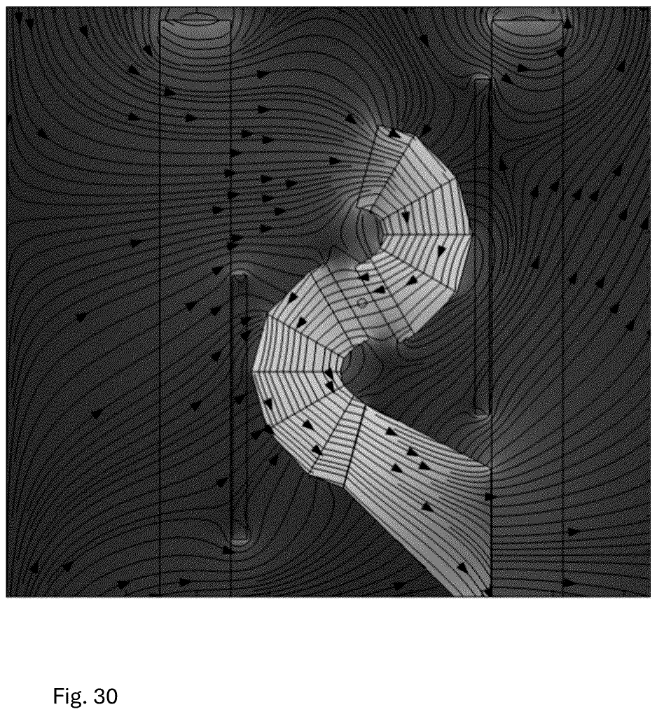

FIG. 30 shows again increasing the strength of the 4TH and 9TH magnets only. 245 mT. 593 mV.

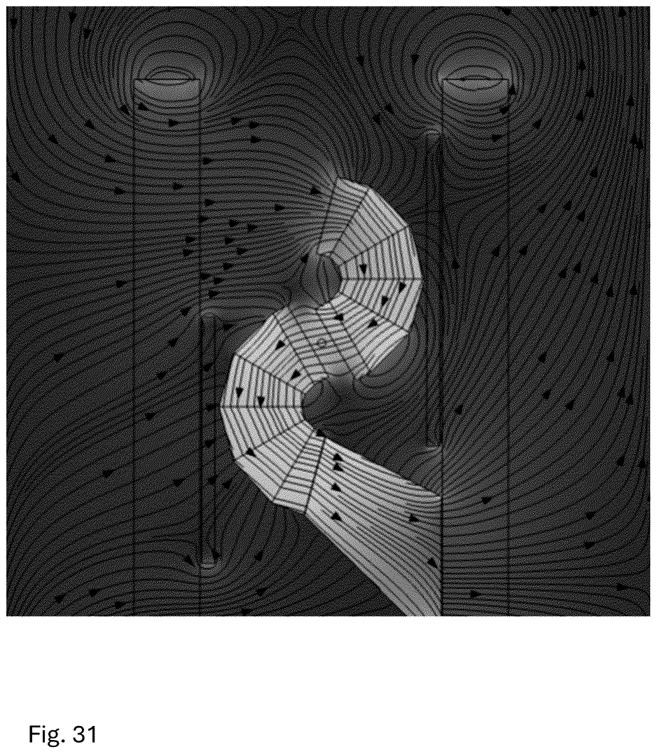

FIG. 31 shows again increasing the strength of the 5TH and 8TH magnets only. 270 mT. 656 mV.

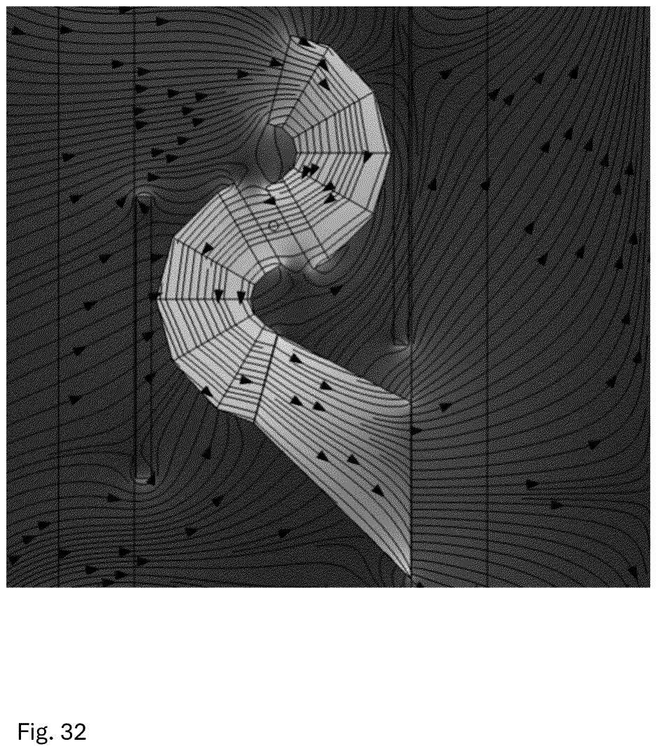

FIG. 32 shows again Increase the strength of the middle magnets only. 263.35 mT. 639.24 mV.

As the stronger magnet positions were moved more centrally, they became more effective, but there was a drop with the most central ones, perhaps because they were thin so the increase power did not equate to as much increased flux.

The next example embodiments include balancing a high number of magnets on both sides plus strong center magnets.

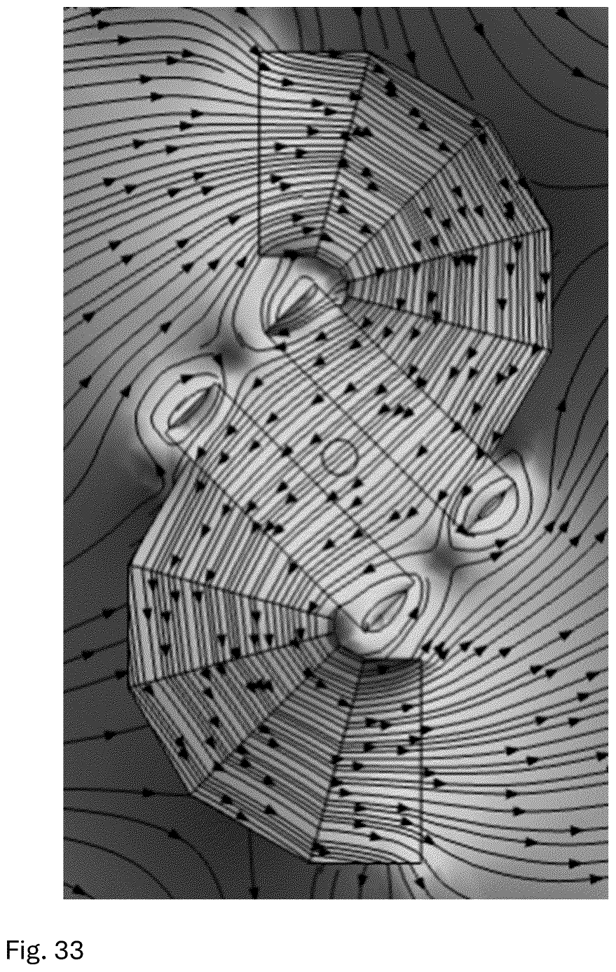

FIG. 33 shows Five magnets on both sides. Center 600 mT. No efflux iron.

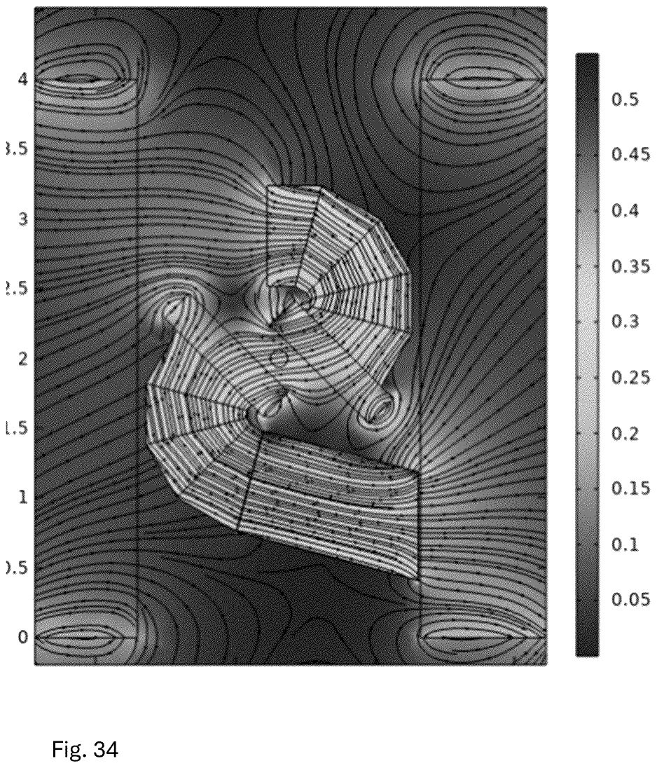

FIG. 34 shows Five magnets on both sides. Center 600 mT. efflux iron provided. 282 mT. 700 mV

This is a very good level of induction. Better would be with blocking magnets and/or more convex airspace, blunt nosed wedges and/or sticking in a reverse wedge, cornucopia horn ingress and outflow. Another outflow magnet wedged the other way would also help. As would have a better central angle, progressively stronger magnets, possibly with stronger and/or longer central magnets. A small amount of inflow iron and having outflow iron progressively widen downward.

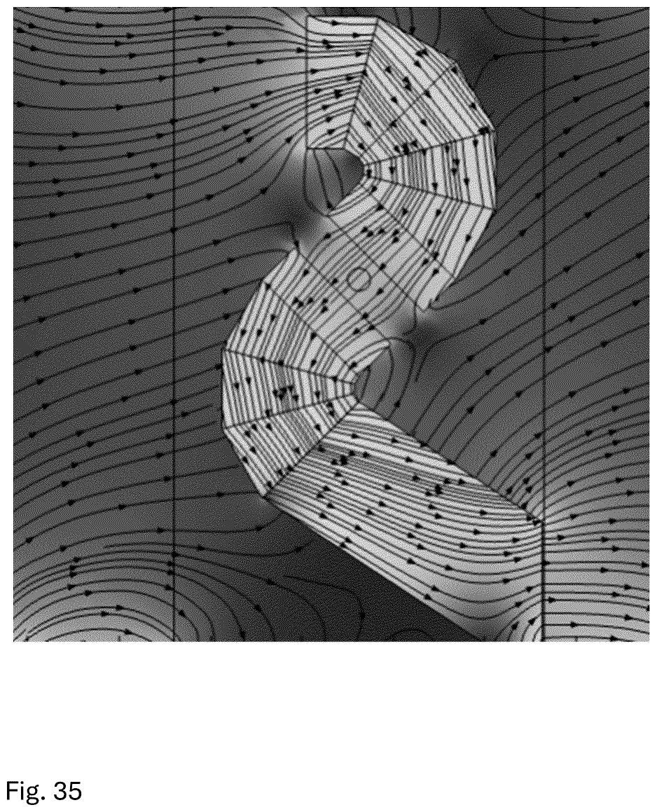

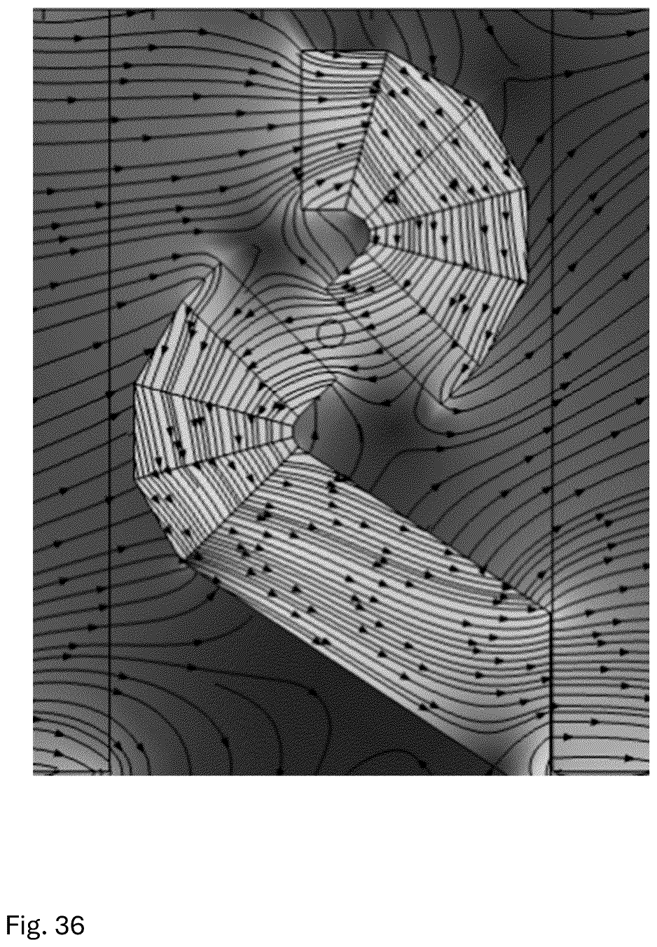

The next example embodiments include changes to middle magnet length. FIG. 35 shows shorter middle magnets unskewed. Field strength: 181 mT. Voltage: 330 mV. FIG. 36 shows shorter middle magnets skewed. Field strength: 190 mT. Voltage: 468.41 mV.

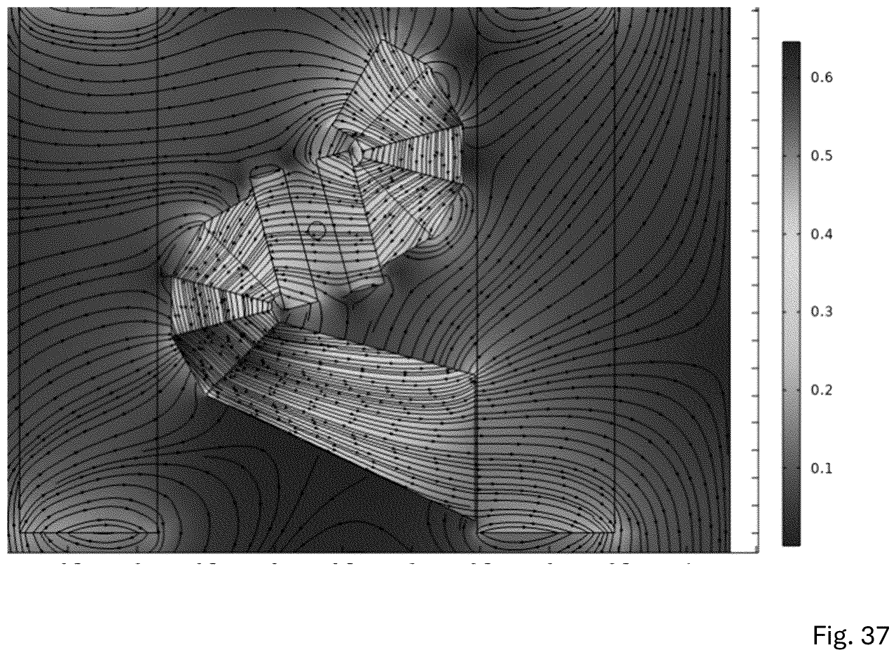

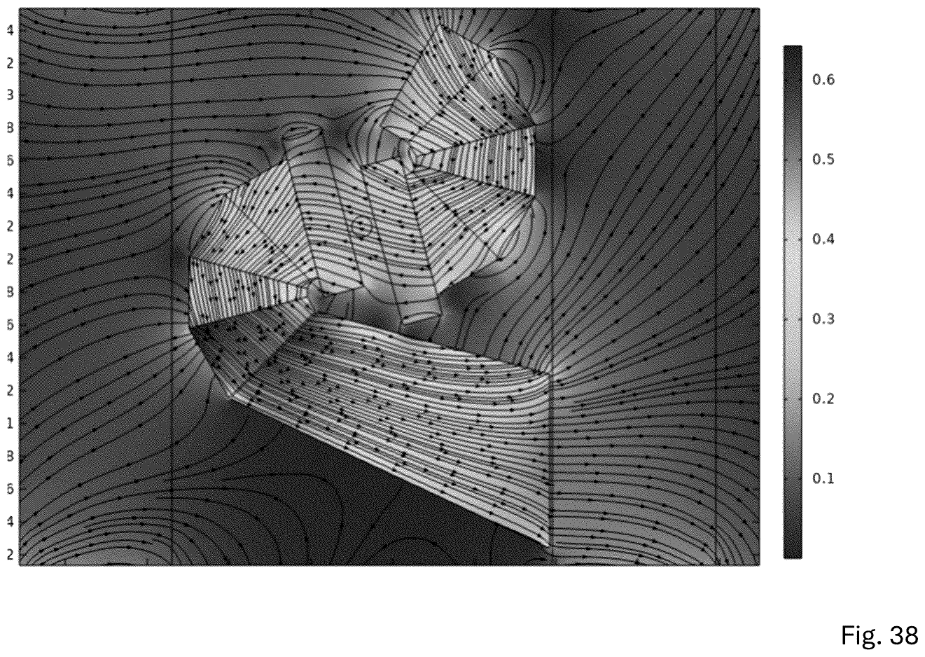

The next example embodiments include changes to rotation and central magnet flux being closer to horizontal before skewing. FIG. 37 shows that the S has been rotated by 30 degrees to bring the gap field to a more preferred angle. No skew. 221.0 mT. 550.8 mV. FIG. 38 shows a rotated version with additional skew, which is beyond ideal in this case. Needs about 10 degrees less for optimum amount. This led to the magnets being slightly closer together resulting in an increased field strength. Good result even with flux being skewed past 180 deg. 255.1 mT. 615.2 mV.

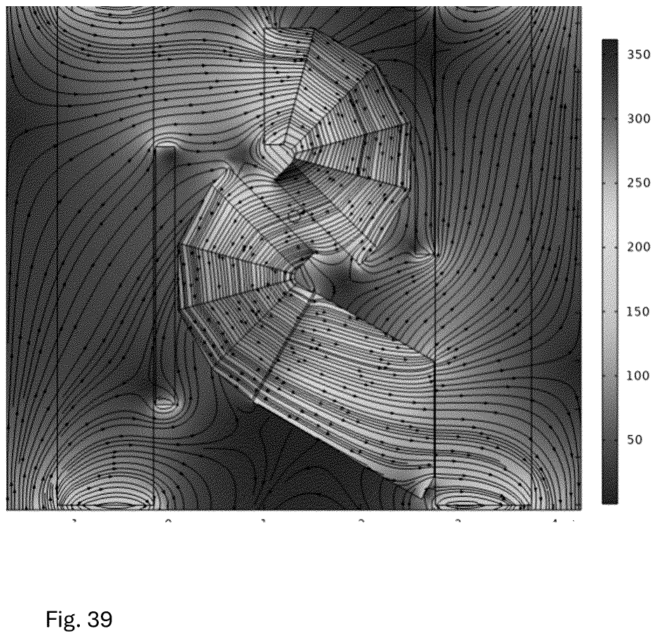

The next example embodiments include blocking magnets. FIG. 39 shows adding 2 blocking magnets and using slightly wider magnets, and moving the wall magnets distance greater by 0.9 in). 250 mT. 563.5 mV.

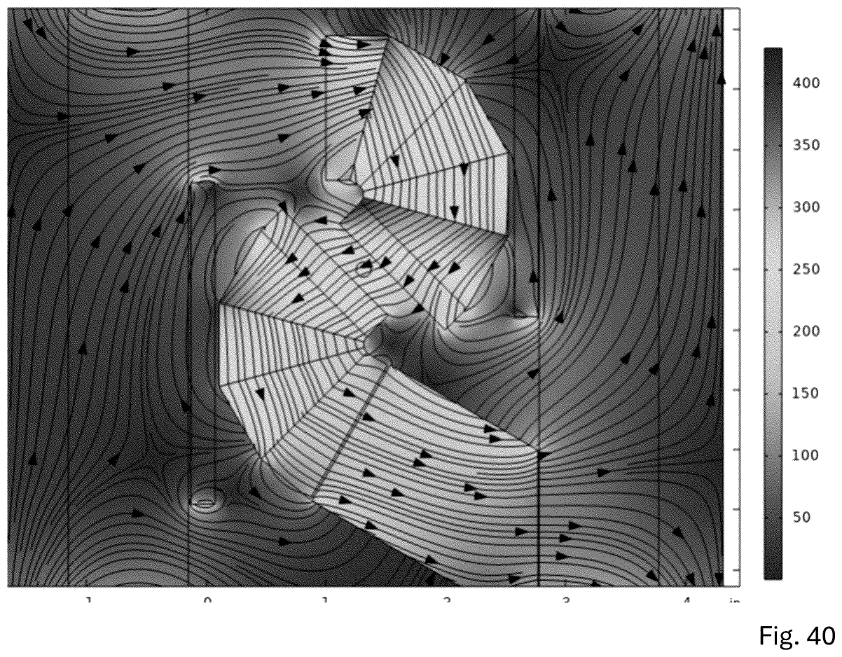

FIG. 40 shows including 2 blocking magnets over convexity, wider stator magnet space, skewed. The second magnet has the wrong magnetization direction. 254 mT. 522 mV.

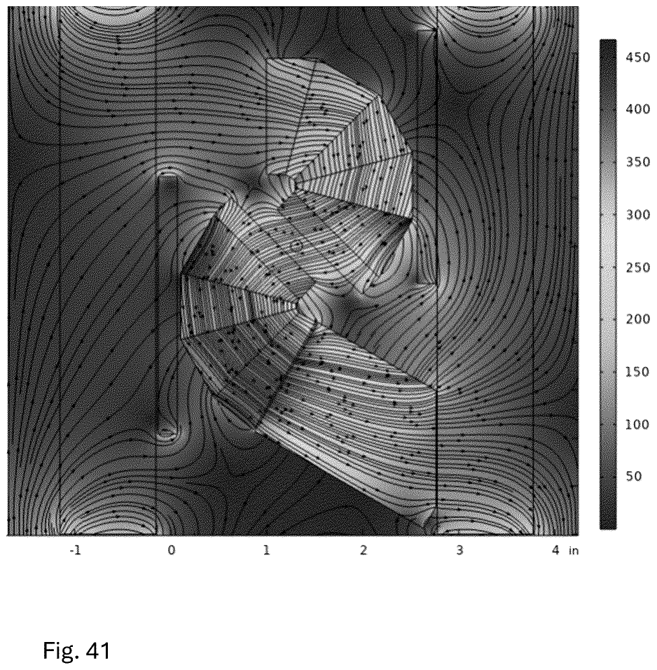

FIG. 41 includes a skewed version of the above and made the magnets have a gradient strength rising as one passes through. The first upper magnets is less 0.4*magnetic strength−0.3−0.2−0.1−0.5. 292 mT. 687.51 mV.

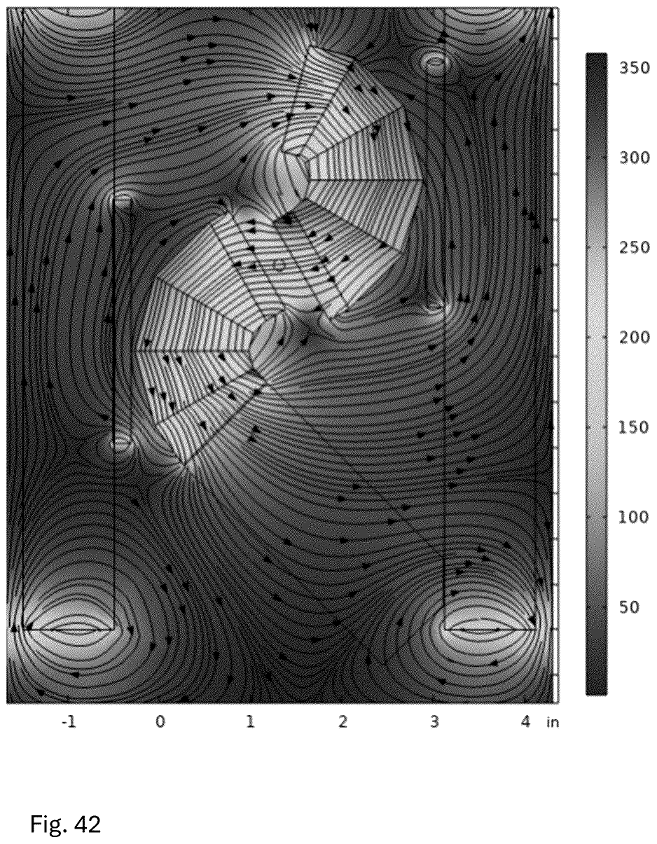

In FIG. 42, the stator magnets are moved further apart and made taller. Also, the S of the flux return is rotated an additional 15 % for a better angle at the gap, and is provided with a small amount of skew. We have used blunt nosed wedges. Note that there are less outflow magnets than inflow in this version. The rear iron appears to be non-permeable. Magnetic strength: 314 mT. Output: 214 mT. 520 mV

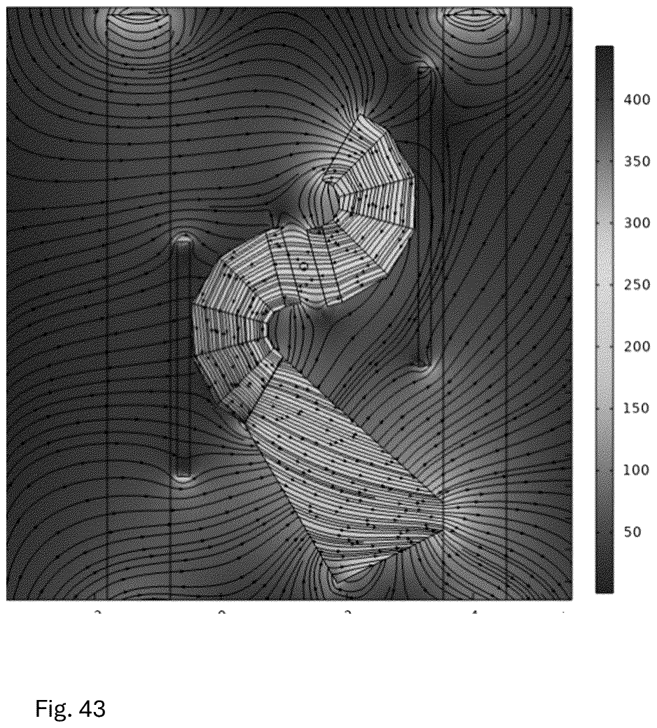

FIG. 43 shows the above, but an additional outflow magnet was added, the tail has been made of a ferromagnetic iron instead of a non-ferromagnetic material. The tail interface with the stator magnet is not the ideal shape. 225 mT. 560 mV.

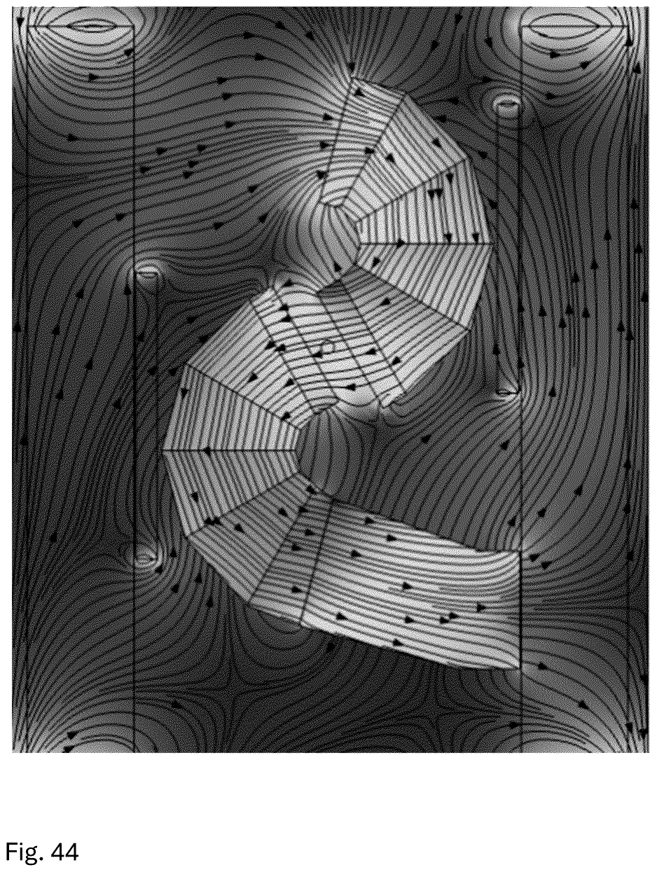

FIG. 44 shows a number of magnets on the upper is equal to the bottom magnets and the tail interface has been improved. Output: 234 mT. 568 mV.

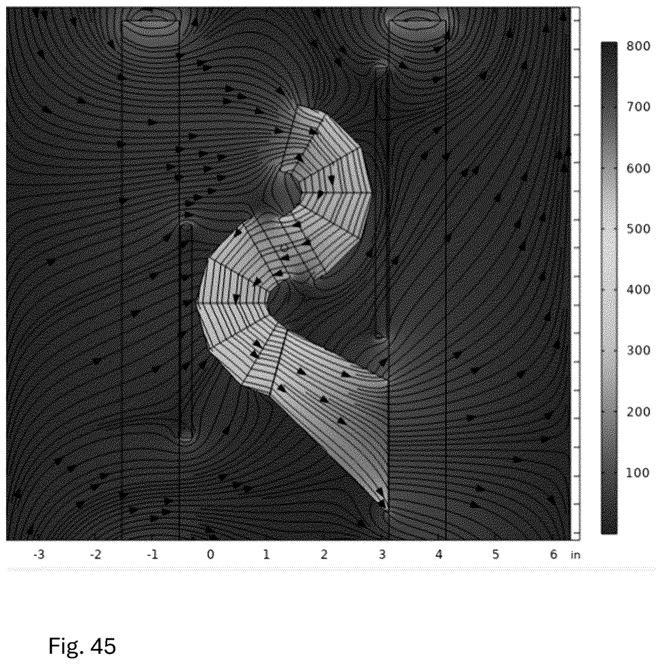

FIG. 45 shows the blocking magnets have been made longer and the iron tail is made to spread out while being directed away from the S of the switchback sides of the flux return. S222.6 mV. 538.22 mT.

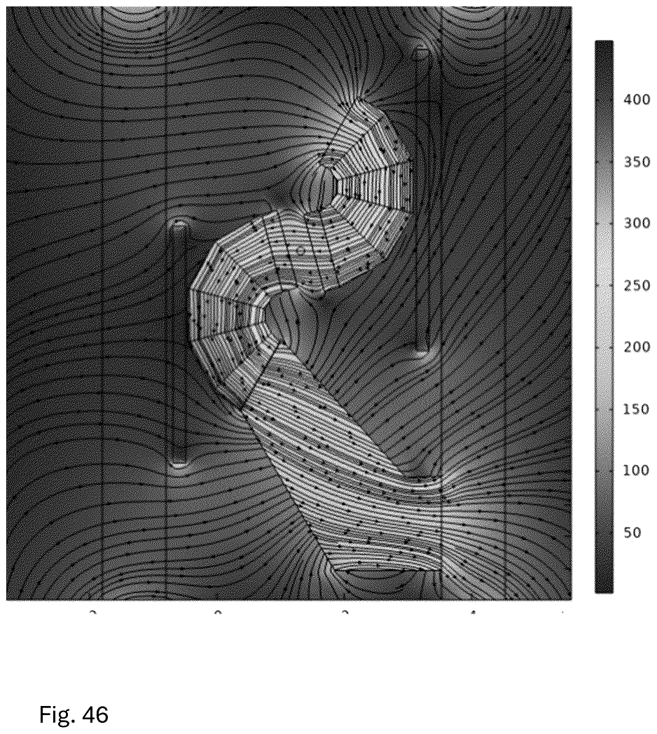

FIG. 46 shows one of many possible tail configurations. 563 mV. 228 mT.

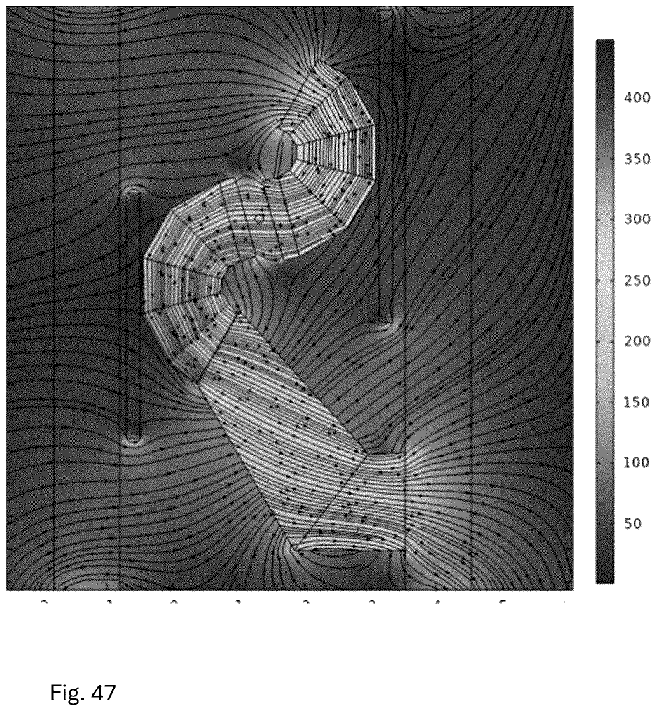

FIG. 47 shows another tail configuration. 562 mV. 228 mT.

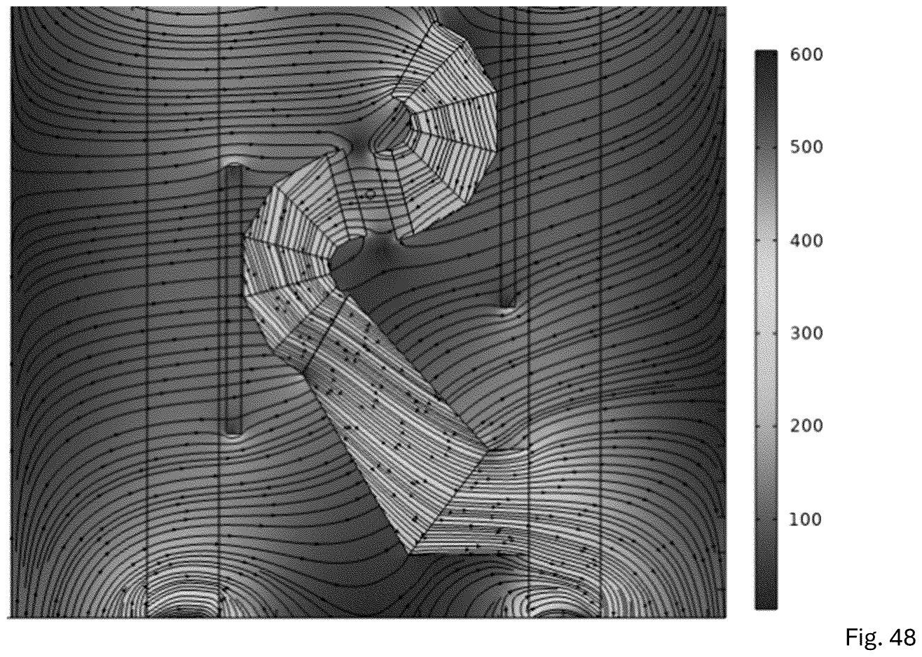

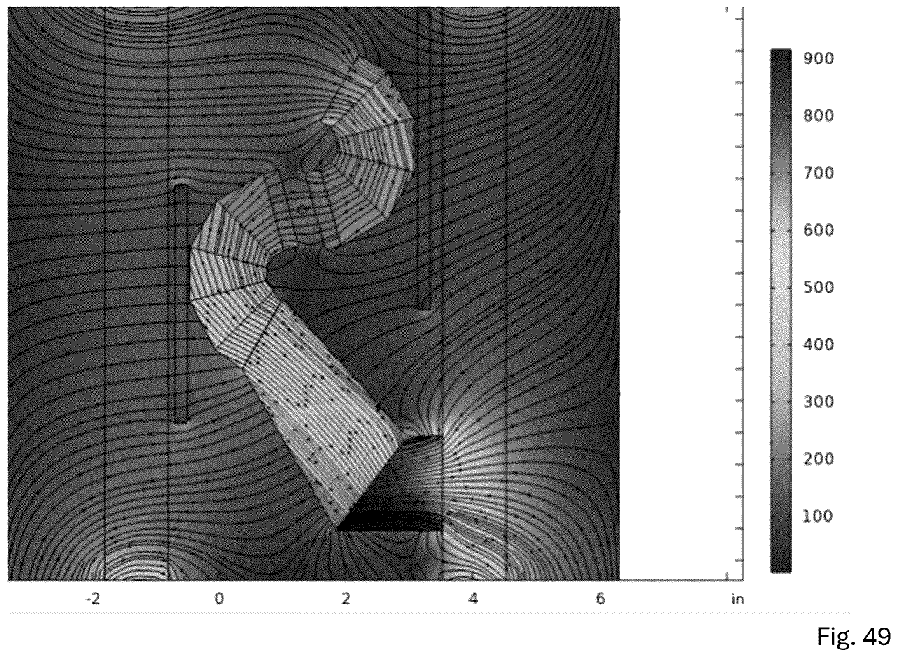

The next example embodiments include increasing the stator magnets' strength to see if we get significant flux flow through. FIG. 48 shows the outer magnets' strength is 1 T Magnet latest part OUTPUT: 161.92 mT. 433 mV. FIG. 49 shows a magnet is added as the last portion of the tail. 166 mT. 446 mV.

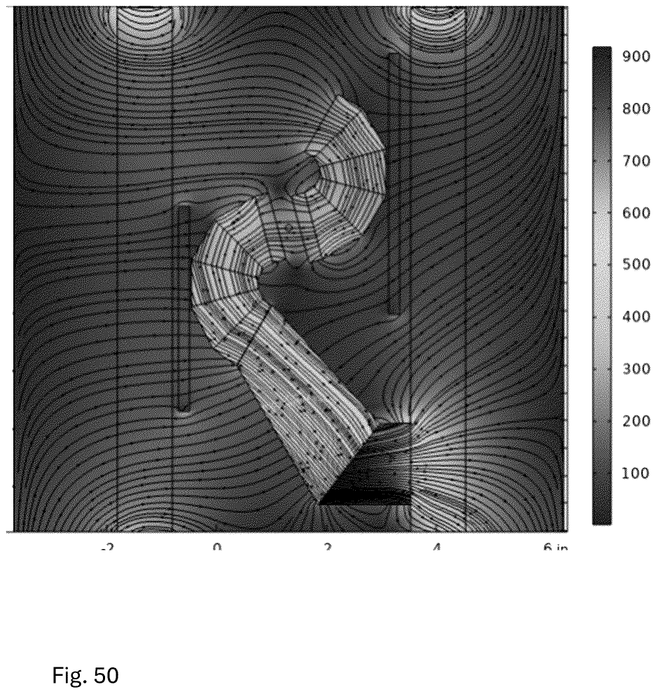

FIG. 50 shows the strength of the 5th and 8th are doubled. Output: 245 mT. Voltage: 637 mV.

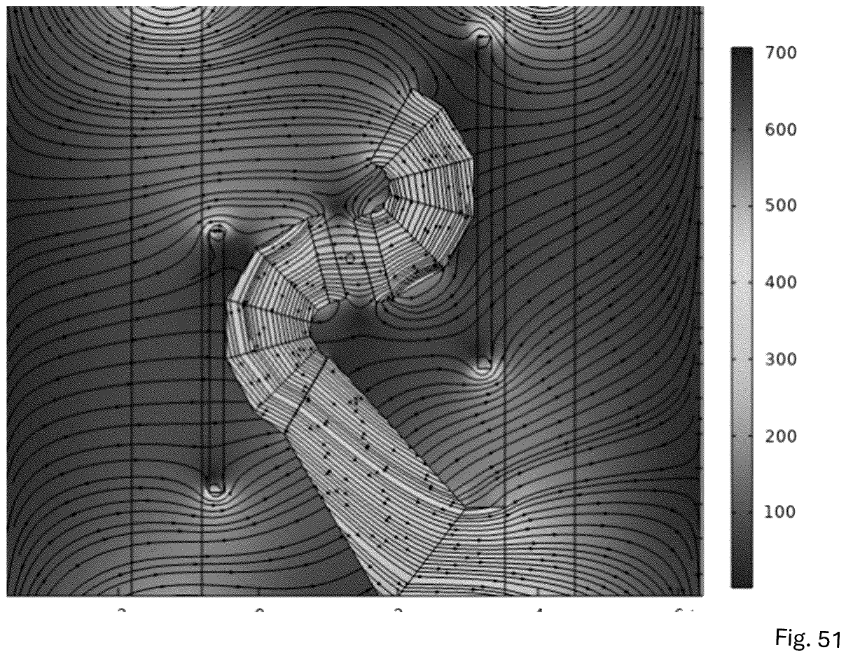

FIG. 51 shows the blocking magnet strength has been increased to 1 T and the tail end piece is now a magnet. The 5th and 8th magnets are double strength. 260 mT. 664 mV.

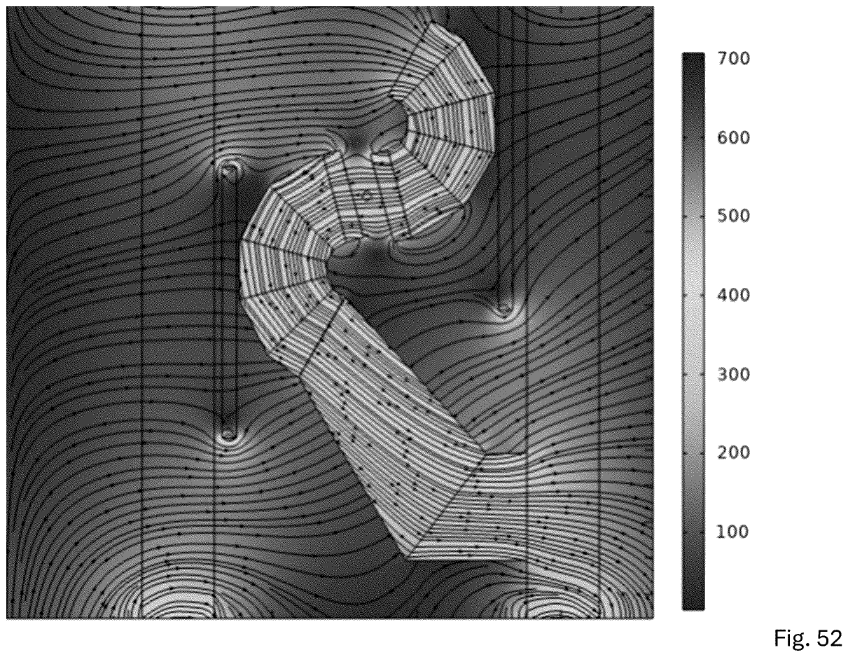

FIG. 52 is the same as FIG. 51 but the central magnets are also doubled in strength. 326 mT. 836 mV.

In addition to permanent magnet materials, example embodiments of the present invention may include flux return structures with switchback portions made of, for example, anisotropic silicon steel. Anisotropic silicon steel is a type of grain-oriented steel that has a non-random orientation of crystals and anisotropic magnetic properties. It's typically used in electrical engineering for applications such as motors, generators, and transformers. The principal also applies to magnets.

Magnetic anisotropy describes how an object's magnetic properties can be different depending on direction. In the simplest case, there is no preferential direction for an object's magnetic moment. It will respond to an applied magnetic field in the same way, regardless of which direction the field is applied. This is known as magnetic isotropy. In contrast, magnetically anisotropic materials will be easier or harder to magnetize depending on which way the object is rotated.

For most magnetically anisotropic materials, there are two easiest directions to magnetize the material, which are a 180° rotation apart. The line parallel to these directions is called the easy axis. In other words, the easy axis is an energetically favorable direction of spontaneous magnetization. Because the two opposite directions along an easy axis are usually equivalently easy to magnetize along, the actual direction of magnetization can just as easily settle into either direction, which is an example of spontaneous symmetry breaking. Using grain oriented laminate iron or silicon steel would improve the tailpiece and anisotropic magnets of the flux return of example embodiments of the present invention and can improve flux directing performance of the S switchback portions.

The following is a list of features which have been included and specifically adjusted in example embodiments of the present invention to improve flux direction and current generation:
Convexity side air gaps-flattening curve, hollowing out flux return, sidewall bulge
   Curved edges
Convexity side blocking magnets
Progressive increase in strength
Strong center magnets
Small influx iron
Full length efflux iron
Wider center magnets with cornucopia shape or wider whole path. 180 degree skew
Increased center mag angle
More efflux mags than influx mags
Blunt nose wedges
Blocking magnets
Sticking in a reverse wedge,
Cornucopia horn ingress and outflow.
Better central angle having outflow iron progressively widen downward.

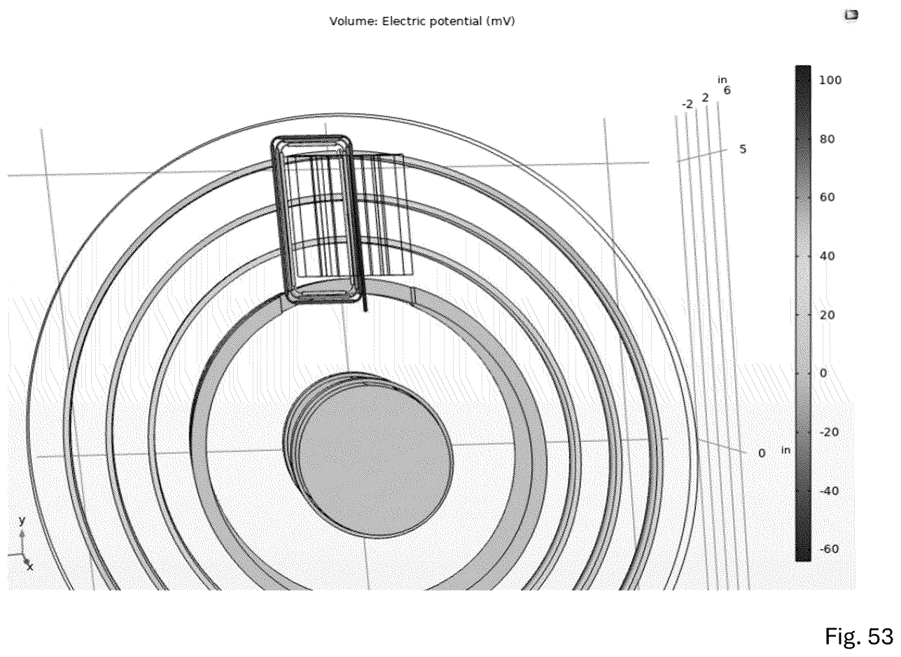

In FIG. 53 the wire of the generator armature has been wound 3 times through the S shield of the flux return (which is on the right side of the loop of the generator armature). The upward (left) side of the wires' loop remains unshielded. Looping the wire through the S gap 3 times gains about 20 MV per turn.

Each downward pass through the S shield of the flux return added additional voltage, but we did not get much addition from the upward side of the coil.

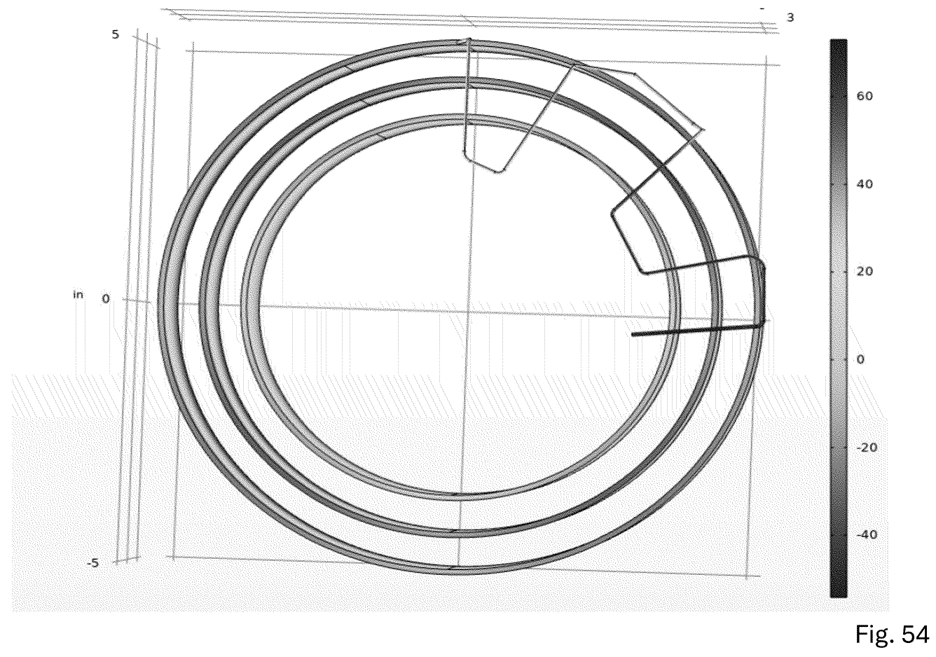

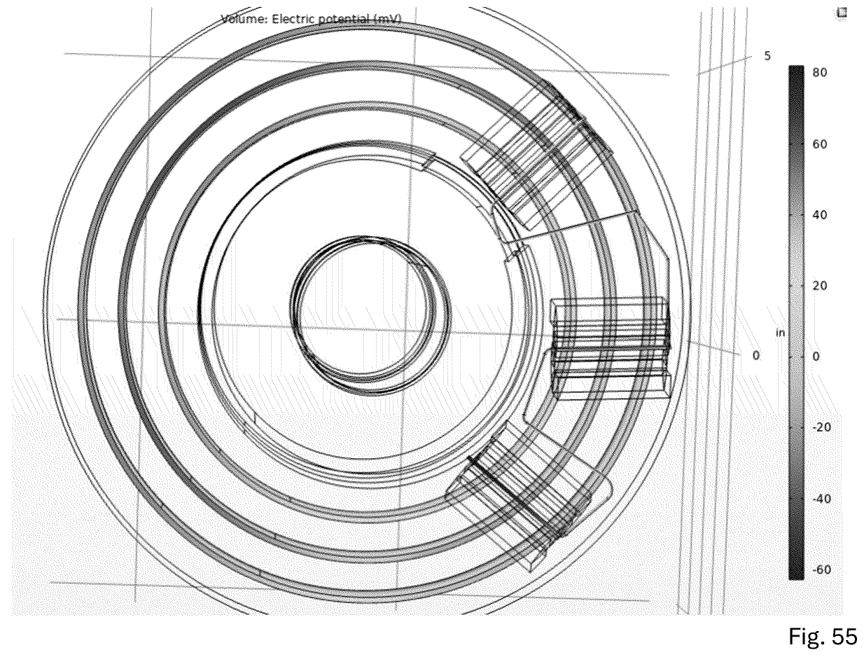

In FIG. 54, three S shield flux returns were used, one on each downward segment of wire. The structures of the three S shield flux returns are not shown in FIG. 54, but are shown in FIG. 55. As compared to the example embodiment of FIG. 53, the example embodiment of FIGS. 54 and 55 gained voltage in each shielded downward segment and also a little in each unshielded upward unshielded segment. In FIGS. 54 and 55, 3 shields are arranged at 45 degrees from one another. This arrangement produced similar results.

There was less positive induction in the unshielded side of the loop than would be expected. In FIG. 48, an example embodiment tests if this was because those wires were right next to the shield by lengthening the horizontal sides of the loop to bring the upward side of the loop further away from the S.

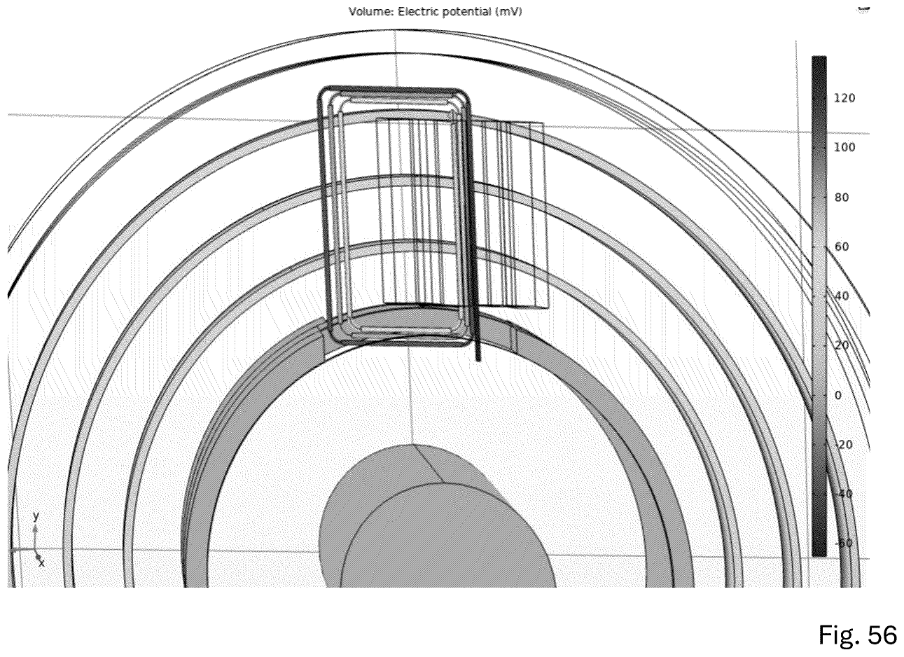

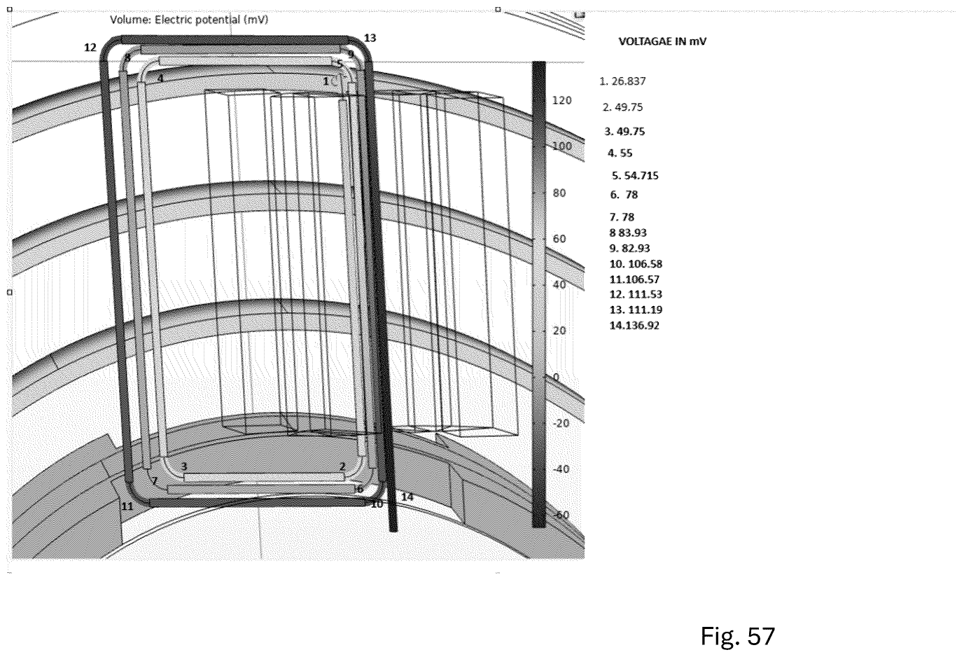

FIG. 56 shows that moving the upswing unshielded side of the coil away from the S of the flux return increased voltage gain a little and FIG. 57 shows voltage readings at various intervals along the coil. The wire comes out of the rotor with 20 mV into the inner upper left corner of the loop. Most of the voltage gain is from the shield functioning well for the descending limb. The ascending limb only gains about 1 mV each pass. Rotating the example embodiment from FIG. 57 45 degrees and moving the ascending side of the loop laterally away

from the shield should result in even more gain.
1st loop voltage goes from 26.8 mV to 54.7 mV=plus 28 mV− only 6 mV from the upswing
2 nd loop: 54.5 mV to 82.9 mV=plus 28 mV, 6 mV from the upswing
3 rd loop: 83 mV to 111 mV=plus 28 mv, 5 mV from the upswing
Last extra leg down: plus 25.7

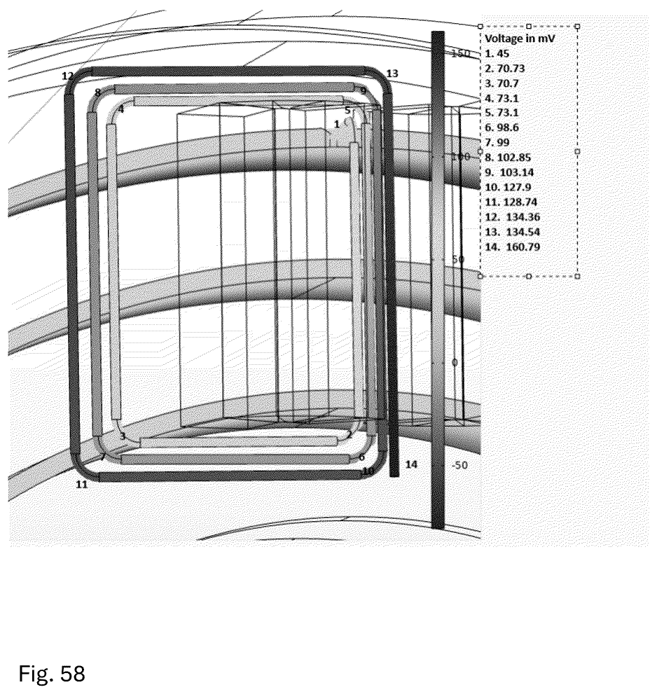

FIG. 58 shows an example embodiment in which the apparatus is rotated by 45 degrees to put the S in a strong spot and got higher values.
Rotor exit 45 mV
1st loop plus 28 mV, 3 from the upswing
2nd loop plus 30 mV, 3 from the up swing
3rd loop pulls 31 mV, 4.5 from the upswing
Final leg plus 26

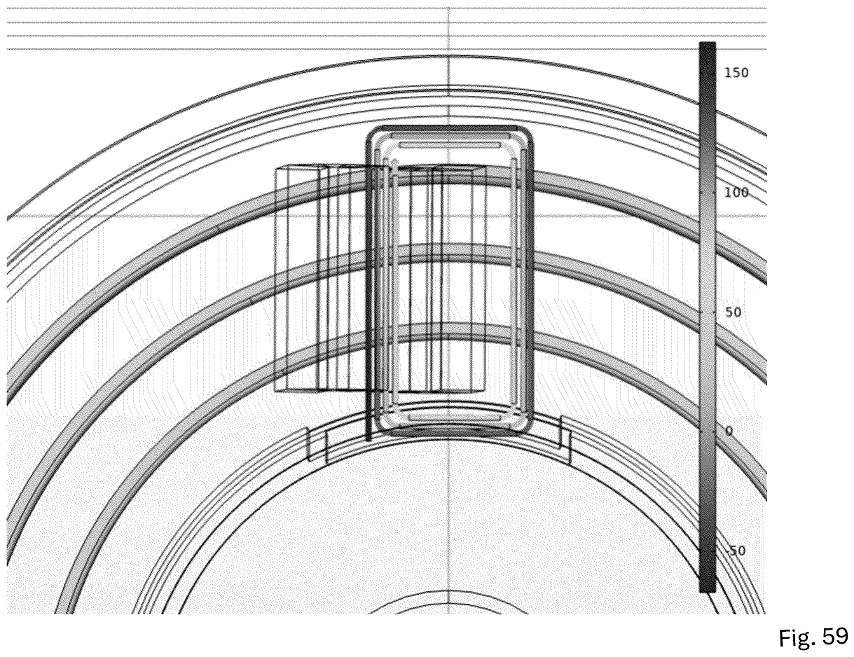

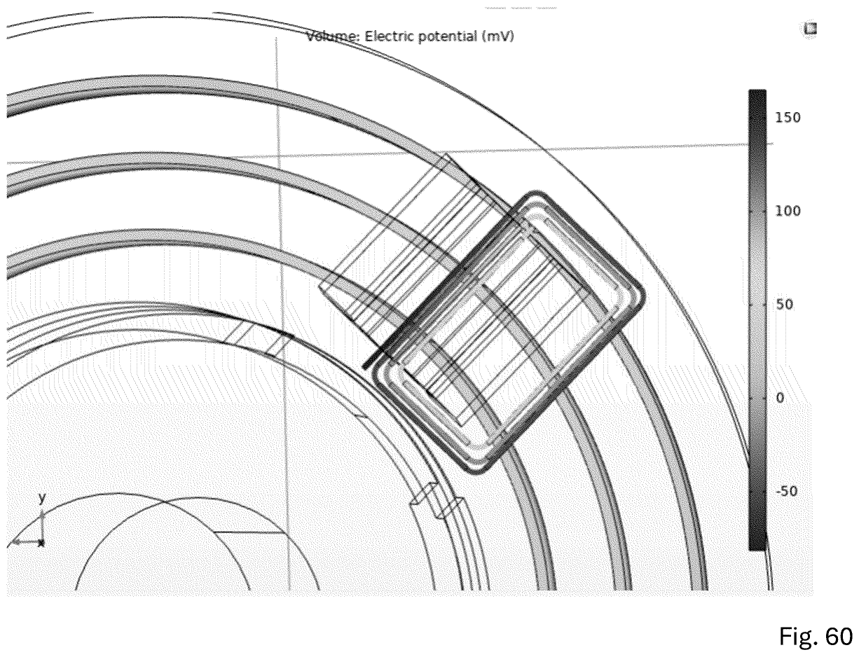

FIGS. 59 and 60 show an arrangement in which the coil was flipped over to bring the upswing to the other side and ran it in the strong and weak spots of the stator field.

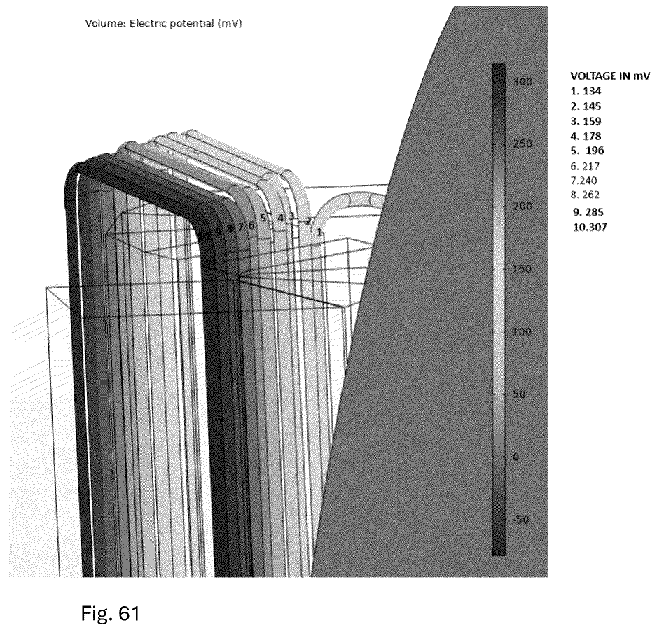

FIG. 61 shows an example embodiment in which the wires of the armature are run through the S of the flux return 10 times to see if there was a diminishment in the voltage adding. However, the rotor made a higher voltage.
Loop 1 added 11 mV
Loop 2 added 14 mV
Loop 3 added 19 mV
Loop 4 added 18 mV
Loop 5 added 21 mV
Loop 6 added 23 mV
Loop 7 added 22 mV
Loop 8 added 23 mV
Loop 9 added 22 mV
Loop 10 was just the down side

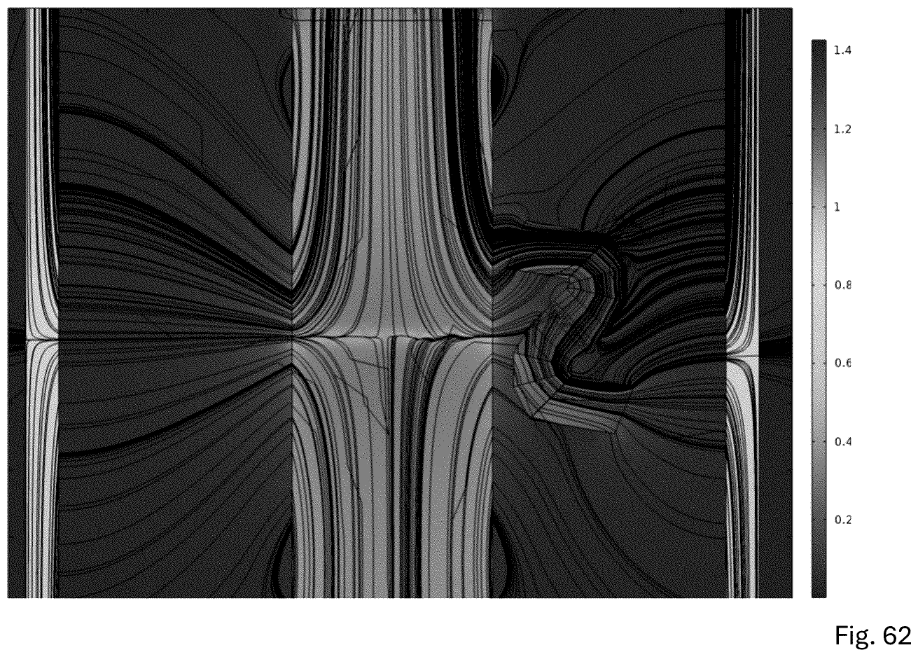

FIG. 62 shows a flux visualization of FIG. 61 through the S showing that the flux concentrates where the strongest induction occurred. In the cut plane of FIG. 62 it is evident that there was a difference in the individual coil turns'effectiveness. The gap flux concentrates on the anti-stator side. That is easily fixed by tweaking the magnets' strength. In FIG. 62, there is also a large amount of convex side leakage. This can be remedied by adding in a large-sized blocking magnet. FIG. 62 shows a rotating state.

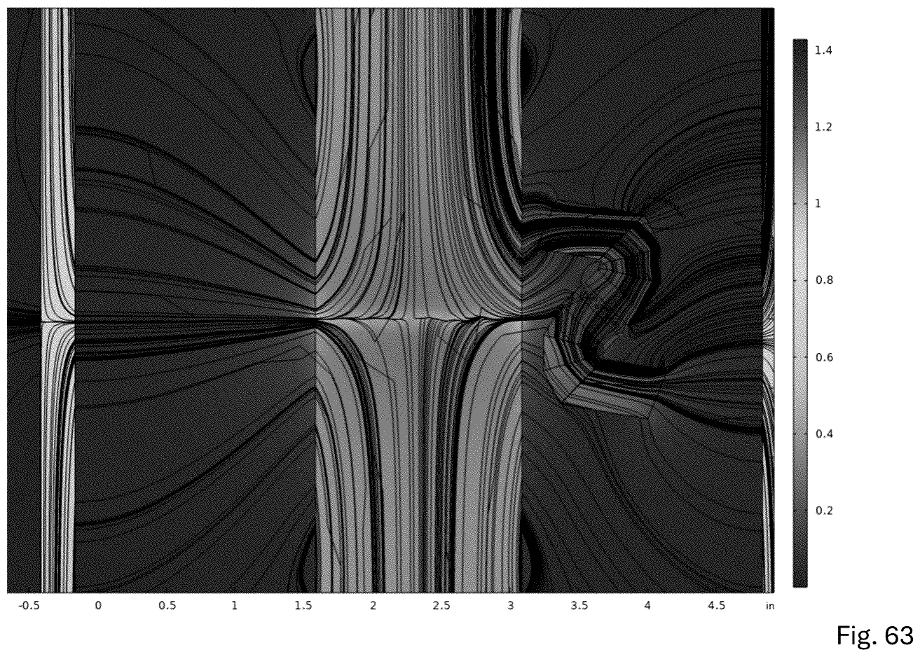

FIG. 63 shows the same arrangement as FIG. 62 but in a stationary state. Even when there is no rotation, the stator flux direction paths are unchanged. Next, this example embodiment will be viewed from the side. Note though that the non-spinning variant convex flux leakage is different, suggesting that the side of the S of the flux return impacts the flux field.

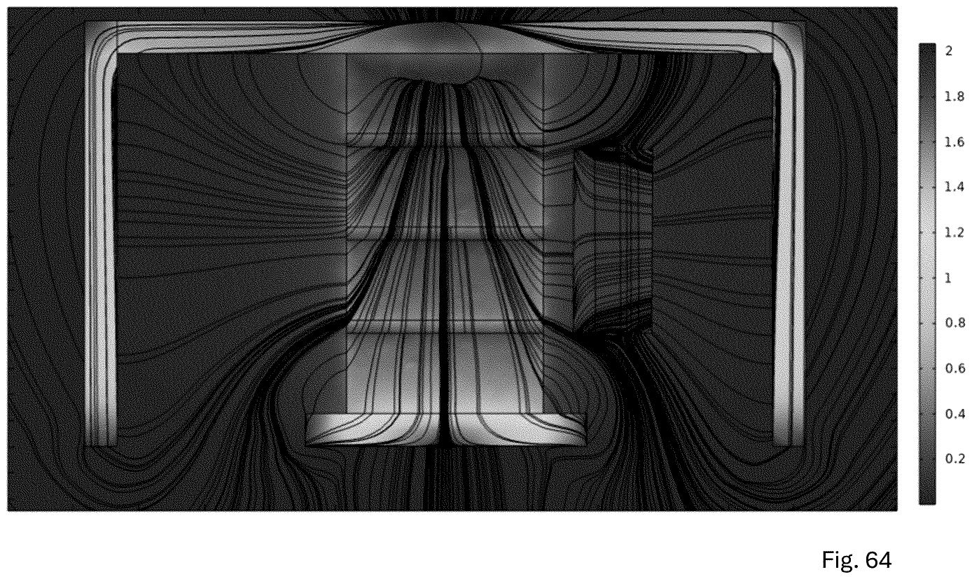

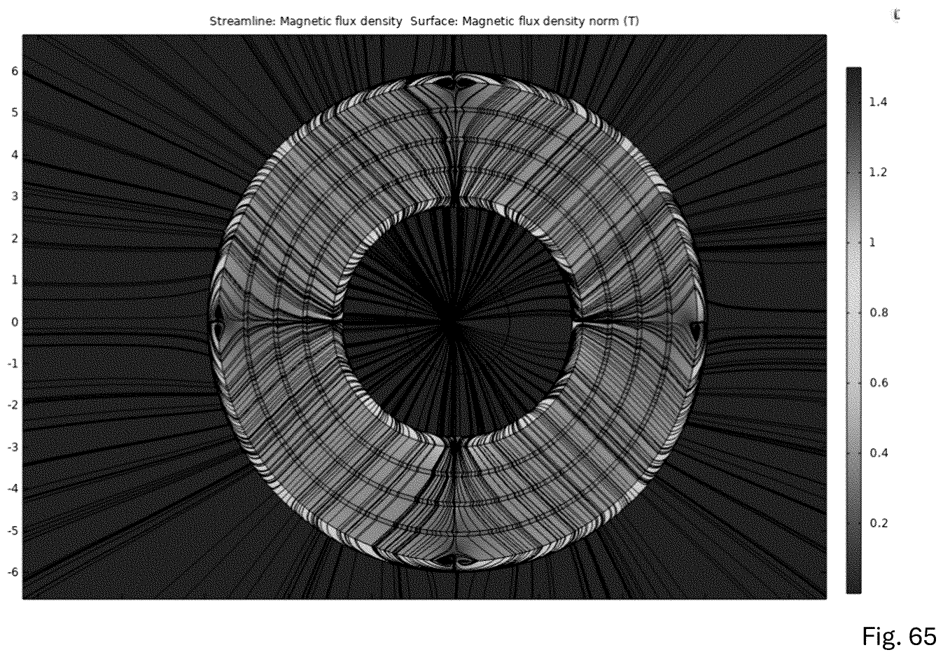

FIGS. 64 and 65 show X and Y cut planes to get a 3D understanding. In FIGS. 64 and 65, it looks like the S is having considerably more leakage at the top and bottom than expected. In this model the S does not go far enough down to most effectively limit excess leakage of flux. Because of this, there is also too much flux shorting into the stators. There is a 60/40 split in the S of flux going down vs up. Ideally, all of the flux would be going down.

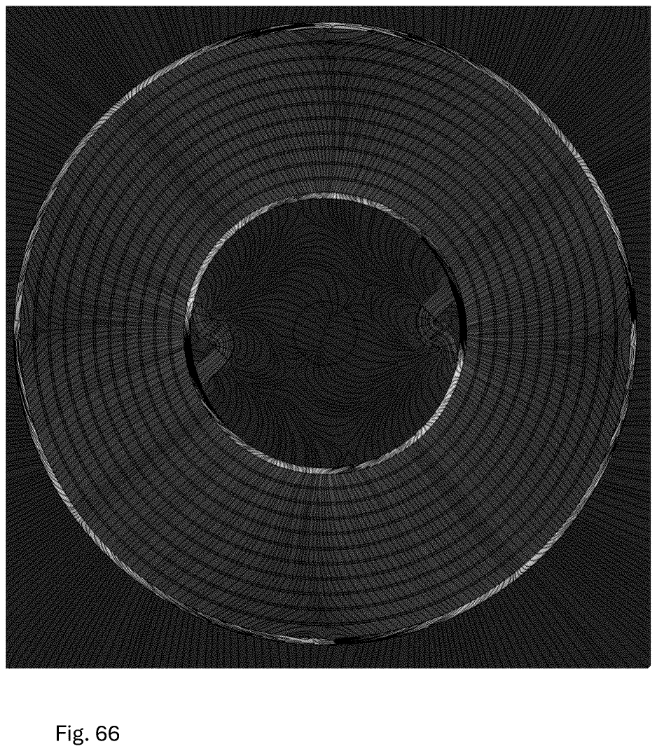

As viewed from the side in FIG. 65, we see that instead of making a truly radial field, the cylinder is divided into quadrants and, in each quadrant, has the flux approaching mostly parallel at a 45 degree angle. This created longitudinal weak and strong areas in the field and corresponding areas of weak and strong voltage in the rotors. Especially when pushing against a resistance, the max output is constrained by the weakest longitudinal path. FIG. 66 shows a bigger model with 10 rotor layers instead of 3. The bigger model has a 24 inch diameter, 100 rpm, revised center shielding. 300 mT stator mags, 600 mT shielding mags.

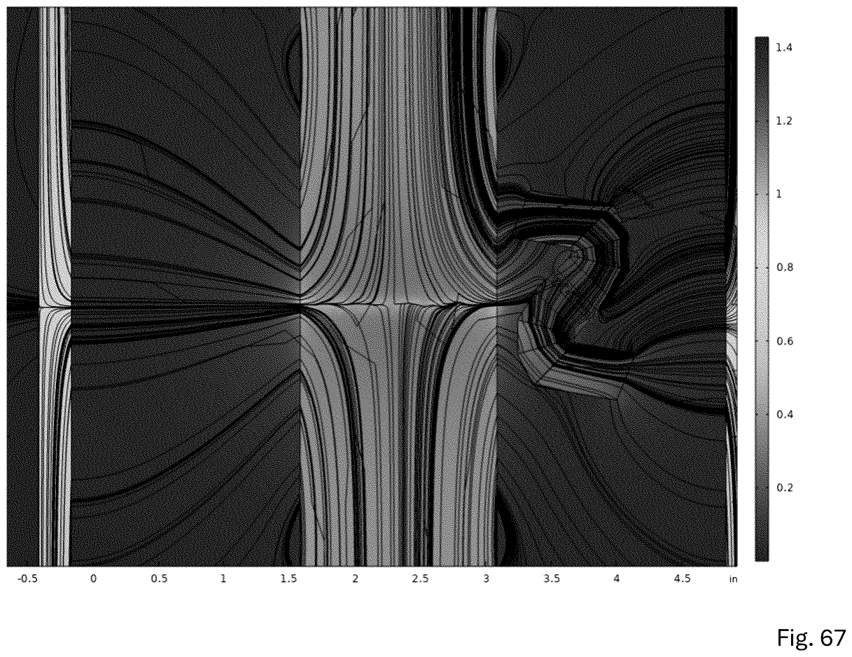

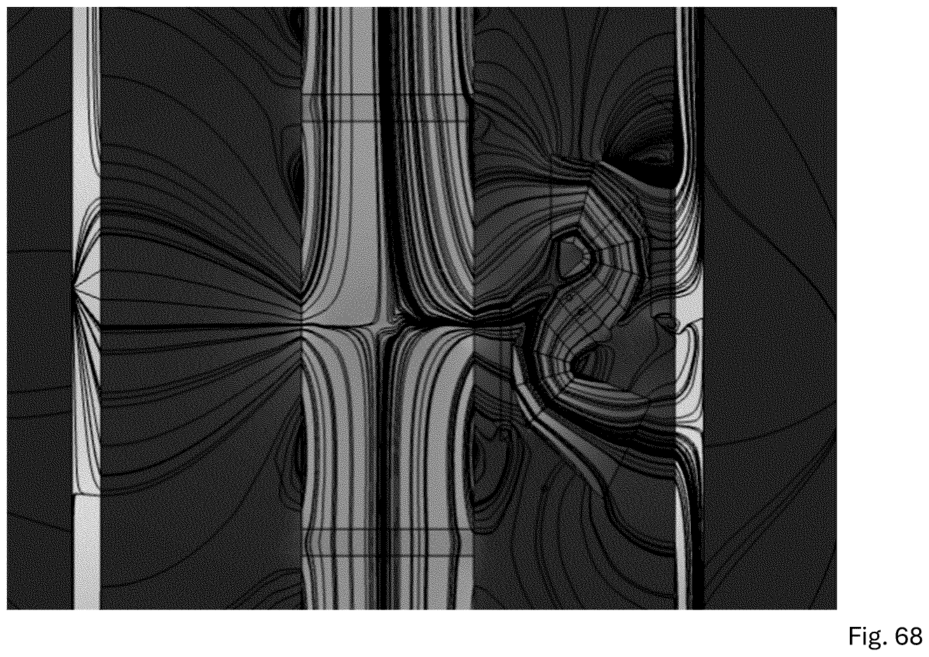

FIGS. 67 and 68 show the effects of blocking magnets. FIG. 67 does not include blocking magnets, and FIG. 68 includes added blocking magnets to provide a form better fitting the convex S outflow curve of the flux return. Some flux still leaks into the outflow convexity, but most is looping around back to the side wall.

The flux leaking out of the influx convexity has moved more distally perhaps because of the flux return of the blocker. A reduction in the strong gap flux area could be addressed by, for example, strengthening the center magnets or the distal ones.

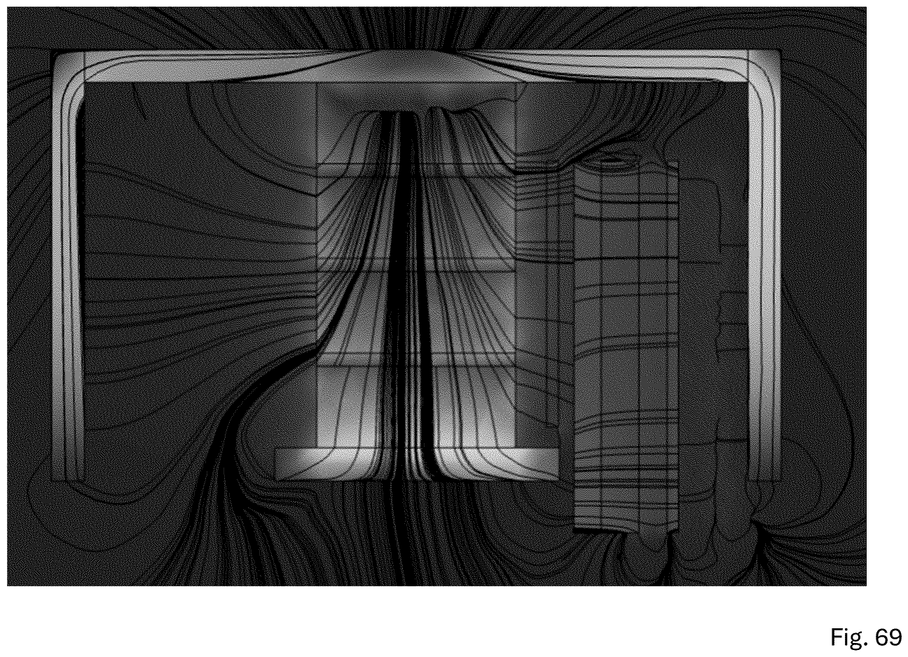

FIG. 69 shows a coronal section with a more appropriately sized height for the S. This example embodiment shows further efficiency losses and opportunities for improvement from this angle. There is a considerable amount of flux being pulled in from above. That will need more space, perhaps by bulging out the outer flux return, tapering/sloping the top of the S, or putting in a blocking magnet.

Also note the amount of flux shorting is too high. The flux needs to be encouraged to go to the inner portion of the flux return. The portion of the inner flux return needs to be thicker and to have enhanced permeability. The S switchbacks need to be farther from the stators, and the out flow iron portion needs to attach directly to the, for example, permanent magnet structure of the inner flux return in as broad an area as possible, keeping it away from the inflow convexity.

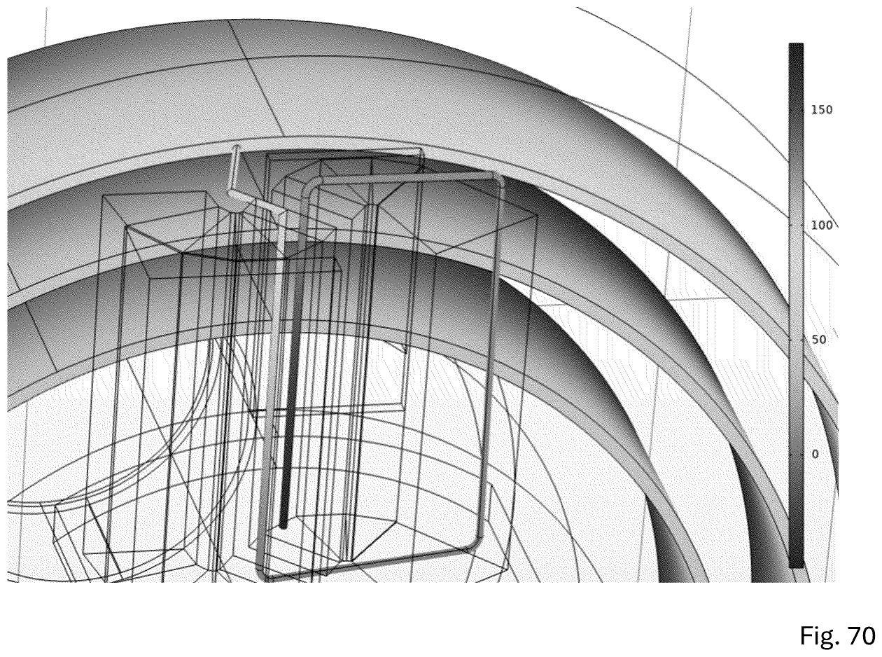

FIG. 70 shows an example embodiment with an improved loop path. On the left the upswing side of the coil is off to the side adjacent to the stator on the influx side of the S switchbacks of the flux return. On the right, the upswing side of the armature coil has been run over to pass by the end surface of the input side of the S switchbacks of the flux return, where there is a greater flux concentration.

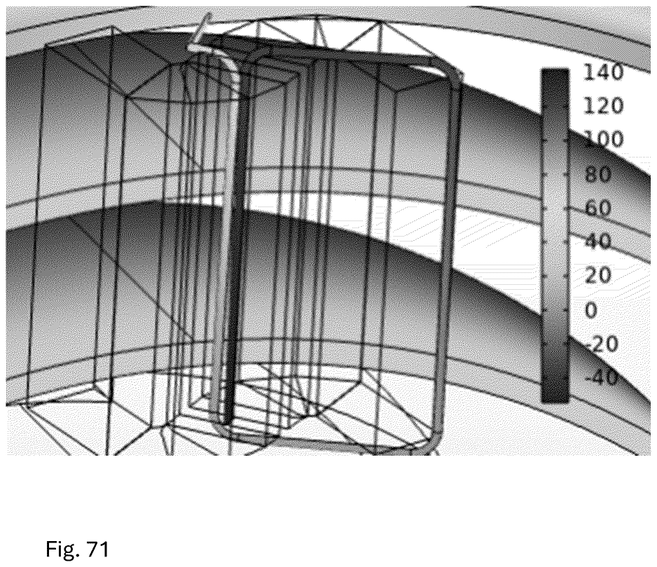

FIGS. 70 and 71 show the routing of the upswing side of the coil of the armature winding into the concentrated flux at the south end of the S switchback of the flux return.

FIG. 70 shows about a 30 MV addition each time the wire goes down the gap in the center of the switchbacks and only a few mV addition from the upswing. However, on the right, the upswing enjoys an additional about 30 mV addition. The same is true if the upswing is positioned in the outflow of the S switchback.

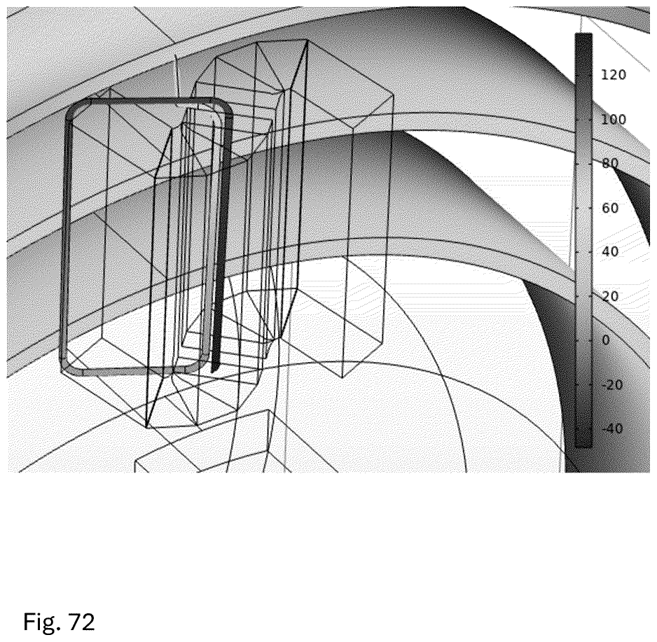

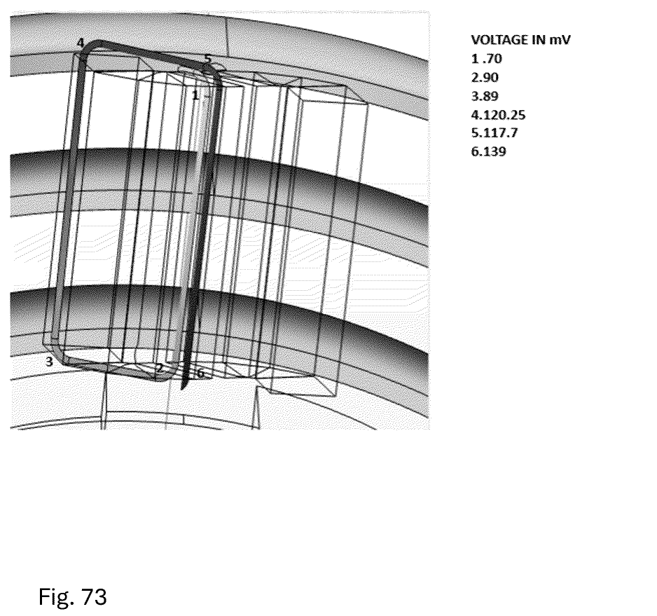

FIG. 72 shows moving the coils, upswing side to the S switchback outflow. north side. FIG. 73 shows voltage values of the arrangement of FIG. 72. Here, the rotor supplies 70 MV, the gap downswing adds about 20 mV per turn, and the upswing is adding 31 mV.

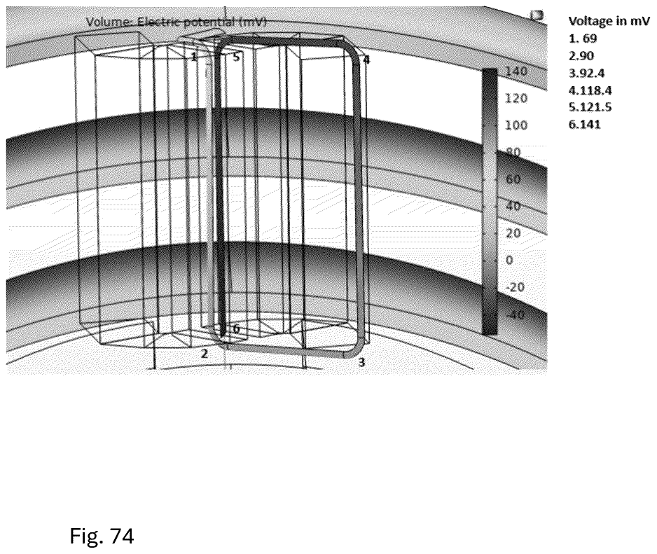

FIG. 74 shows an example embodiment in which the coils are moved to the influx side upswing shows voltage coming from the rotor at 70 mV, gaining about 20 mV per turn in the gap downswing, and gaining 36 mV in the upswing.

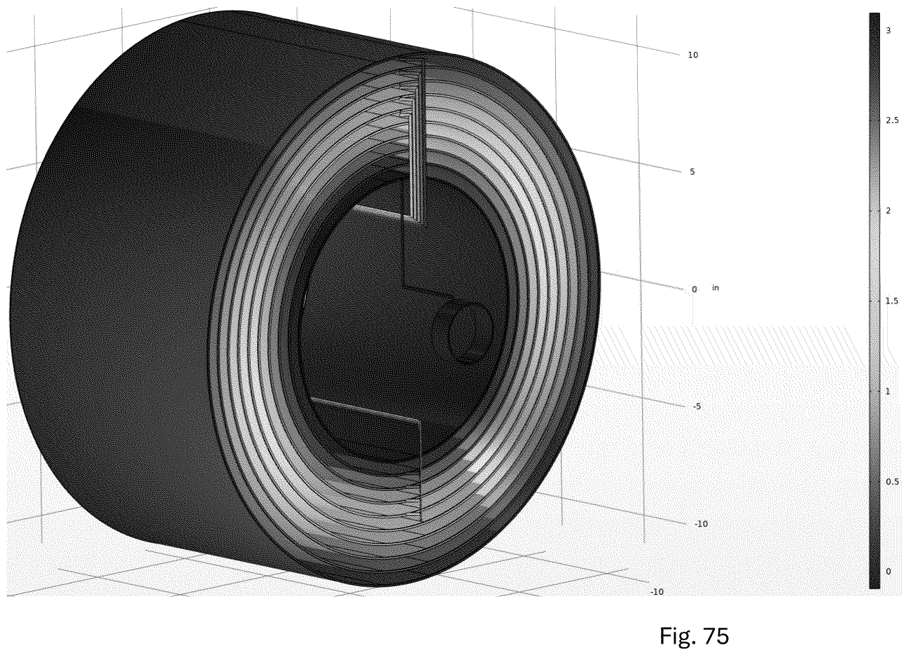

FIG. 75 shows an unenhanced big model of an example embodiment of a stator rotor complex according to the present invention looking at voltage levels. We start by making everything that is not copper invisible and spinning it at 100 rpm. We see clear adding of rotor voltage. Each rotor is making about 200 mV and the wires are contributing an additional 100 mV.

Next, focusing on what portions of the wire of the armature coil are contributing how much voltage we see that we lose a couple of millivolts in the unshielded section of wire, gaining roughly 25-50 mv in each vertical wire section (depending on length) and gaining roughly 70-80 mv in horizontal wire sections depending on length.

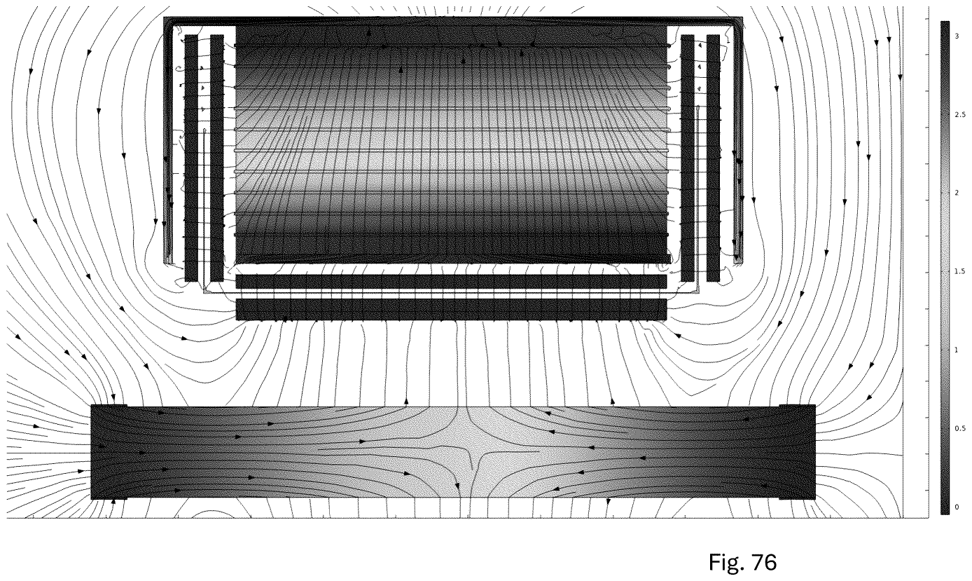

FIG. 76 shows a side view cross section of a stator rotor complex according to an example embodiment of the present invention and 1 wire showing progressive voltage gain throughout at 100 rpm.

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A homopolar dynamoelectric machine comprising:
stator layers spaced radially apart from one another;
rotor layers each respectively provided between a pair of the stator layers and rotatable through a stationary magnetic field generated by the stator layers;
electrical windings which electrically connect axial ends of the rotor layers in series, parallel, or a combination of series and parallel; and
at least one flux return mitigation assembly to interact with flux of the magnetic field generated by the stator layers; wherein
the at least one flux return mitigation assembly includes a switchback structure which is contoured to direct the flux of the magnetic field generated by the stator layers through a portion of the electrical windings.

2. The homopolar dynamoelectric machine according to claim 1, wherein the portion of the electrical windings passes through a gap at a center of the at least one flux return mitigation assembly.

3. The homopolar dynamoelectric machine according to claim 1, wherein the at least one flux return mitigation assembly includes a series of paired individual axial or diametric magnets which are spaced apart to create an inter-magnet field in a gap between the series of paired individual axial or diametric magnets.

4. The homopolar dynamoelectric machine according to claim 3, wherein the series of paired individual axial or diametric magnets define an S shape of the switchback structure.

5. The homopolar dynamoelectric machine according to claim 1, wherein the at least one flux return mitigation assembly includes permanent magnet structures and/or iron cores which are shaped to direct the flux of the magnetic field generated by the stator layers through the portion of the electrical windings.

6. The homopolar dynamoelectric machine according to claim 1, wherein the at least one flux return mitigation assembly includes two of the at least one flux return mitigation assemblies located on at least one axial end of the homopolar dynamoelectric machine.

7. The homopolar dynamoelectric machine according to claim 1, wherein
the switchback structure includes two opposing curved portions; and
the portion of the electrical windings passes through a gap defined between opposing surfaces of the two opposing curved portions.

8. The homopolar dynamoelectric machine according to claim 7, wherein
the two opposing curved portions are defined by multiple permanent magnet and/or iron portions.

9. The homopolar dynamoelectric machine according to claim 8, wherein
a first one of the two opposing curved portions includes more of the multiple permanent magnet and/or iron portions than a second one of the two opposing curved portions does.

10. The homopolar dynamoelectric machine according to claim 8, wherein
at least one of the first one of the two opposing curved portions and the second one of the two opposing curved portions includes a blocking magnet at an outermost end thereof in a flux flow direction.

11. The homopolar dynamoelectric machine according to claim 7, wherein
the two opposing curved portions include opposing permanent magnet block portions on opposing surfaces thereof.

12. The homopolar dynamoelectric machine according to claim 7, wherein
the opposing surfaces of the two opposing curved portions are skewed relative to one another.

13. The homopolar dynamoelectric machine according to claim 1, wherein
the stator layers include permanent magnets to generate the stationary magnetic field; and
the rotor layers include conductive portions that are rotatable through the magnetic field to produce an electric current in the portion of the electrical windings.

14. The homopolar dynamoelectric machine according to claim 1, wherein the switchback structure has a symmetrical shape with respect to a position of the portion of the electrical windings.

15. The homopolar dynamoelectric machine according to claim 1, wherein a plurality of the at least one flux return mitigation assemblies are provided on a same axial surface of the homopolar dynamoelectric machine.

16. The homopolar dynamoelectric machine according to claim 1, wherein the portion of the electrical windings include multiple coils of a wire which the switchback structure is contoured to direct the flux of the magnetic field generated by the stator layers through.

17. An electrical power generator comprising the dynamoelectric machine according to claim 1.
